(19) United States
(12) Patent Application Publication
(10) Pub. No.: US 2026/0298305 A1
(43) Pub. Date: Oct. 1, 2026

(54) ENERGY ABSORBING MEMBER

(71) Applicant: G-TEKT CORPORATION, Saitama (JP)

(72) Inventors: Koji Nariya, Tokyo (JP); Shun Takaoka, Tokyo (JP); Takashi Kubo, Tokyo (JP); Hiroki Ito, Tokyo (JP)

(21) Appl. No.: 19/489,928

(22) PCT Filed: Aug. 29, 2024
(86) PCT No.: PCT/JP2024/030907

§ 371 Date: Dec. 4, 2025

(30) Foreign Application Priority Data
Oct. 10, 2023 (JP) 2023-174894

(51) Int. Cl. F16F 7/12

(52) U.S. Cl. CPC F16F 7/128

(57) ABSTRACT

An energy absorbing member (10) is configured such that a first plate portion (41) and a pair of second plate portions (42 and 42) mold a basic unit (20) having a U-shaped cross-section which is molded as a press-molded article. An inner surface (21) and an outer surface (22) of the basic unit (20) configured to have a U-shaped cross-section have a contour without an undercut shape in a direction along a reference line (CL2). The first plate portion (41) and the pair of second plate portions (42 and 42) each have an imaginary parallelogram (90) that is biased about an axis (CL1) from a first end face (51) to a second end face (52) of the basic unit (20). At least one of two diagonals (91 and 92) of the imaginary parallelogram (90) is molded by a fold line.

### TECHNICAL FIELD

The present invention relates to an energy absorbing member.

### BACKGROUND ART

In recent years, development has progressed on energy absorbing members that enhance their energy absorption capability through their own collapse. A technology for such energy absorbing members is disclosed in, for example, Patent Document 1.

The energy absorbing member disclosed in Patent Document 1 uses an inverted spiral folding structure. The inverted spiral folding structure is a structure in which, for example, when side surfaces constituting a hexagonal prism are folded along fold lines provided on the side surfaces, an upper end face and a lower end face collapse in a spiral manner while being inverted relative to each other, and the side surfaces are folded so as to come into close contact with each other. It is said that this energy absorbing member exhibits a large amount of energy absorption and a large reaction force.

### CITATION LIST

### Patent Document

Patent Document 1: Japanese Unexamined Patent Publication No. 2011-058579

### Disclosure of the Invention

### Problem to be Solved by the Invention

In the energy absorbing member disclosed in Patent Document 1, since it is necessary to mold a large number of fold lines on a member having a tubular shape, and different cross-sections are molded along the axis, for example, processing by a hydroforming method can be considered. However, hydroforming equipment is specialized and large in size, and as the length of a tubular material increases, it becomes more difficult to control the hydraulic pressure applied inside the tubular material, and therefore, pressure unevenness is likely to occur, uneven processing is also likely to occur, and processing costs also increase.

An object of the invention is to provide a technology that enables easy mass production of an energy absorbing member at a relatively low cost through press molding.

### Means for Solving Problem

As a result of diligent research, the present inventors have focused on the cross-sectional shape of the energy absorbing member. That is, it has been discovered that the energy absorbing member can be press-molded by employing an inverted spiral folding structure with an open cross-section, rather than a tubular closed cross-section. It has been found that, by configuring the energy absorbing member so as to have a U-shaped cross-section, the energy absorbing member can be press-molded even when having an inverted spiral folding structure. The invention has been completed based on this finding.

According to the present disclosure, there is provided an energy absorbing member in which one member configured to have a U-shaped cross-section by a first plate portion and a pair of second plate portions extending from both edges of the first plate portion in a direction in which the second plate portions face each other is defined as a basic unit molded as a press-molded article, in which a straight line passing through a space surrounded by the first plate portion and the pair of second plate portions and extending in a direction along each plate surface of the first plate portion and the pair of second plate portions is defined as an axis of the basic unit, in which a straight line orthogonal to the axis and extending in a direction intersecting the plate surface of the first plate portion is defined as a reference line of the basic unit, in which one end face of the basic unit in a direction along the axis is defined as a first end face, and the other end face is defined as a second end face, in which an inner surface and an outer surface of the basic unit configured to have a U-shaped cross-section have a contour without an undercut shape in a direction along the reference line, in which the first plate portion and the pair of second plate portions each have an imaginary parallelogram that is biased about the axis from the first end face to the second end face, and in which at least one of two diagonals of the imaginary parallelogram is molded by a fold line.

### Effect of the Invention

According to the present disclosure, it is possible to provide a technology that enables easy mass production of an energy absorbing member with high energy absorption performance at a relatively low cost through press molding.

### BRIEF DESCRIPTION OF DRAWINGS

FIG. 1 is a perspective view of an energy absorbing member according to a first embodiment;

FIG. 2 is a perspective view of one basic unit illustrated in FIG. 1;

FIG. 3 is an end face view of a first end face of the basic unit when viewed in the direction of arrow 3 in FIG. 2;

FIG. 4 is an end face view of a second end face of the basic unit when viewed in the direction of arrow 4 in FIG. 2;

FIG. 5A is a view of the energy absorbing member when viewed in the direction of arrow 5A in FIG. 1, and FIG. 5B is a view of the energy absorbing member when viewed in the direction of arrow 5B in FIG. 5A;

FIG. 6 is an enlarged view of an imaginary parallelogram illustrated in FIG. 5A;

FIG. 7A is a perspective view of an energy absorbing member according to a second embodiment, and FIG. 7B is a view taken in the direction of arrow 7B in FIG. 7A;

FIG. 8 is a view of an energy absorbing member according to a third embodiment when viewed from the first end face side;

FIG. 9 is a view of an energy absorbing member according to a fourth embodiment when viewed from the first end face side;

FIG. 10A is a perspective view of an energy absorbing member according to a fifth embodiment, and FIG. 10B is a view taken in the direction of arrow 10B in FIG. 10A;

FIG. 11A is a plan view of an energy absorbing member according to a sixth embodiment, and FIG. 11B is a view of the energy absorbing member when viewed in the direction of arrow 11B in FIG. 11A;

FIG. 12 is a perspective view of an energy absorbing member according to a seventh embodiment;

FIG. 13A is a perspective view of one basic unit illustrated in FIG. 12, and FIG. 13B is an enlarged view of a flange illustrated in FIG. 13A;

FIG. 14A is a view of the basic unit when viewed in the direction of arrow 14A in FIG. 13, and FIG. 14B is an end face view of the second end face of the basic unit when viewed in the direction of arrow 14B in FIG. 13;

FIG. 15A is a perspective view of an energy absorbing member according to an eighth embodiment, and FIG. 15B is a view taken in the direction of arrow 15B in FIG. 15A;

FIG. 16A is a schematic view (reproduced view) of the energy absorbing member illustrated in FIG. 12, FIG. 16B is a view of the energy absorbing member illustrated in FIG. 16A with press-molding end portions separated, and FIG. 16C is a view of two energy absorbing members illustrated in FIG. 16B that are superimposed;

FIG. 17A is a perspective view of an energy absorbing member according to a ninth embodiment, FIG. 17B is a view of a basic unit when viewed in the direction of arrow 17B in FIG. 17A; FIG. 17C is a cross-sectional view taken along line 17C-17C in FIG. 17A; and FIG. 17(d) is an enlarged view of portion 17D in FIG. 17C;

FIG. 18A is a perspective view of an energy absorbing member according to a tenth embodiment, and FIG. 18B is a cross-sectional view taken along line 18B-18B in FIG. 18A;

FIG. 19 is a perspective view of a crash box constituted by an energy absorbing member according to an eleventh embodiment;

FIG. 20A is a perspective view of an energy absorbing member according to a twelfth embodiment, and FIG. 20B is an end face view of the energy absorbing member when viewed in the direction of arrow 20B in FIG. 20A; and

FIG. 21 is a perspective view of an energy absorbing member according to a thirteenth embodiment.

### BEST MODES FOR CARRYING OUT THE INVENTION

Embodiments of the invention will be described below with reference to the accompanying drawings. Incidentally, the modes illustrated in the accompanying drawings are merely examples of the invention, and the invention is not limited to the modes.

### First Embodiment

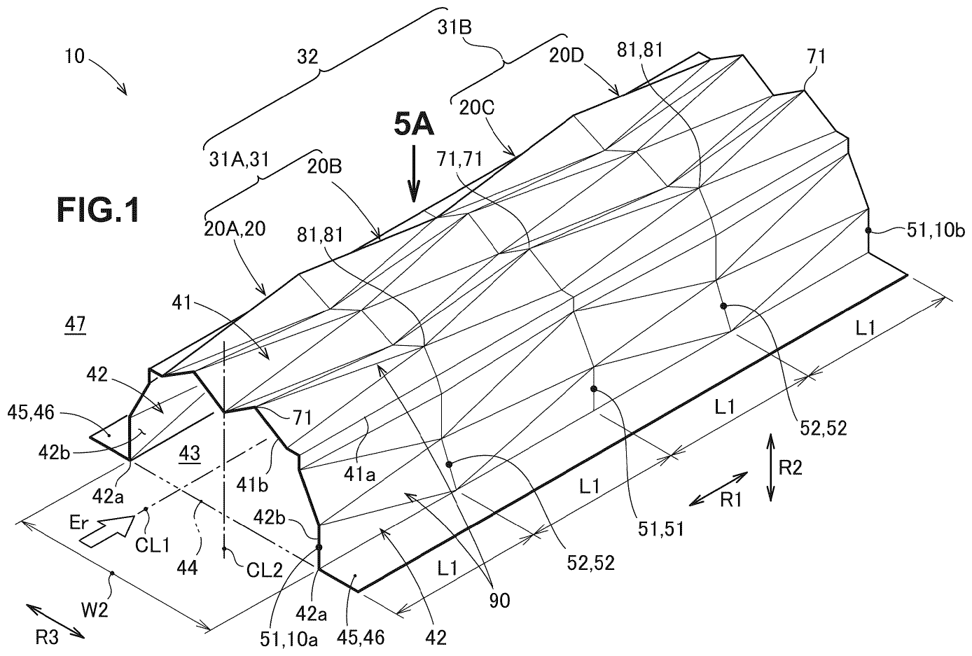

An energy absorbing member 10 of a first embodiment will be described with reference to FIG. 1 to FIG. 6.

FIG. 1 illustrates an overall structure of the energy absorbing member 10. The energy absorbing member 10 is configured in an inverted spiral folding structure by a plurality of basic units 20 (partial structures 20) that are molded continuously and integrally. The inverted spiral folding structure is a structure in which, when the energy absorbing member 10 is folded along a plurality of fold lines provided on the side surfaces, the portions between both end faces 10a and 10b of the energy absorbing member 10 in a longitudinal direction R1 collapse in a spiral manner while being inverted relative to each other, thereby folding the energy absorbing member 10 such that the side surfaces come into close contact with each other.

The material of the energy absorbing member 10 may be any material as long as the material is plastically demoldable. The material is, for example, a steel sheet; preferably, a high-strength steel sheet such as a high-tensile steel sheet contributes to weight reduction. The energy absorbing member 10 may also be an injection-molded resin article, a cast article, or the like, but is, for example, a press-molded article molded by press-molding a flat plate-shaped material.

The energy absorbing member 10 will be described in more detail.

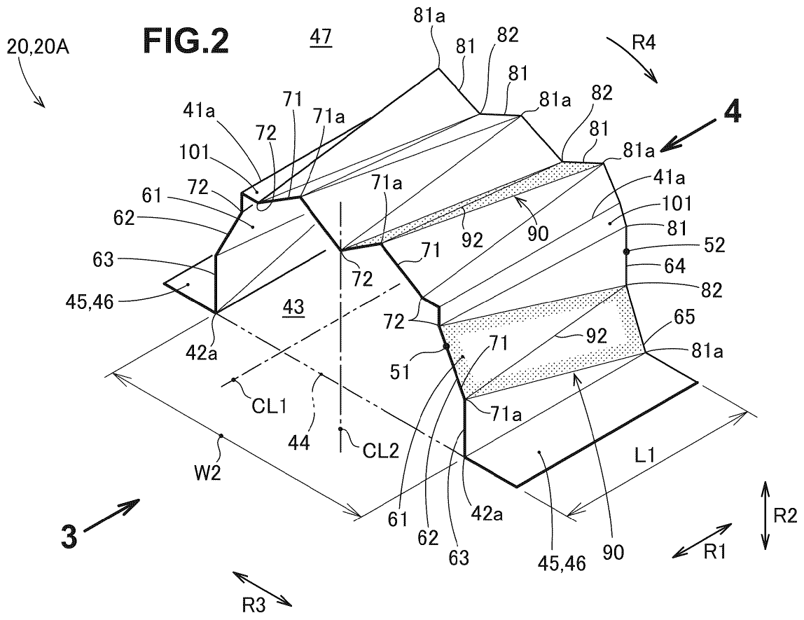

As illustrated in FIG. 1 and FIG. 2, the energy absorbing member 10 is configured such that one set of two basic units 20 and 20 constitutes one unit group 31. At least two sets of the unit groups 31 and 31 are continuous with each other along an axis CL1 of the energy absorbing member 10, thereby molding one elongated member 32. Therefore, all the basic units 20 that are continuous with each other are integrally molded as a single elongated member 32. In this way, the energy absorbing member 10 includes the elongated member 32 elongated in an axis CL1 direction. When the energy absorbing member 10 receives energy (external force) in the axis CL1 direction, the energy absorbing member 10 absorbs the energy by undergoing inverted spiral deformation at the fold line portions along the entire length of the elongated member 32.

For example, the elongated member 32 is composed of two sets of the unit groups 31 and 31. In this case, the energy absorbing member 10 is composed of four basic units 20. Hereinafter, an example of four basic units 20 will be described. Incidentally, when the four basic units 20 are to be distinguished from each other in the following description, alphabets are added to the reference numeral 20, and the basic units are referred to as a first basic unit 20A, a second basic unit 20B, a third basic unit 20C, and a fourth basic unit 20D. In addition, when the two sets of unit groups 31 and 31 are to be distinguished in the following description, alphabets are added to the reference numeral 31, and the unit groups are referred to as a first unit group 31A and a second unit group 31B.

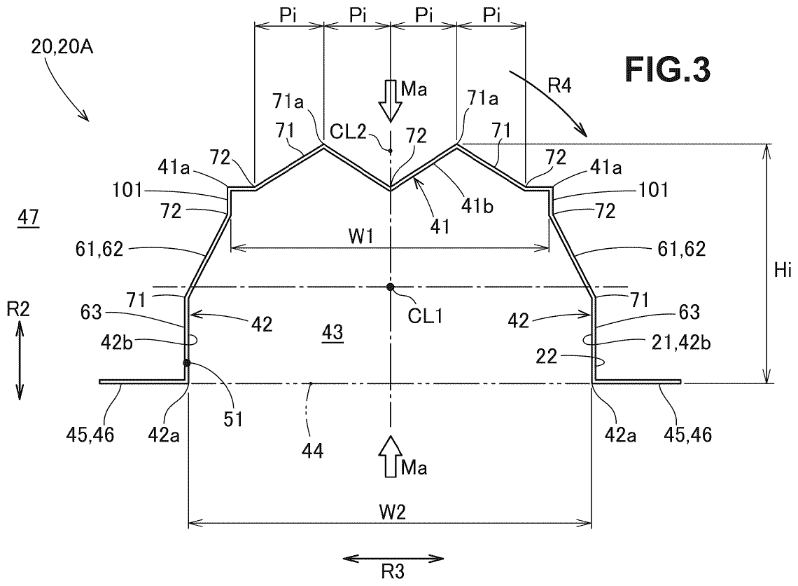

Referring also to FIG. 3, the energy absorbing member 10 (each basic unit 20) is configured to have a U-shaped cross-section by a first plate portion 41 and a pair of second plate portions 42 and 42 extending from both edges 41a and 41a of the first plate portion 41 in a direction in which the second plate portions 42 and 42 face each other. Ends 42a and 42a of the second plate portions 42 and 42 on the side opposite both edges 41a and 41a of the first plate portion 41 are referred to as “open-side end portions 42a and 42a”. Furthermore, the energy absorbing member 10 (each basic unit 20) has a space 43 (internal space 43) surrounded by the first plate portion 41 and the pair of second plate portions 42 and 42. A region between the open-side end portions 42a and 42a of the pair of second plate portions 42 and 42 is an open end 44 communicating with the internal space 43.

Here, the energy absorbing member 10 (each basic unit 20) is defined as follows. The axis CL1 of the energy absorbing member 10 (each basic unit 20) is a straight line passing through the internal space 43 surrounded by the first plate portion 41 and the pair of second plate portions 42 and 42, and extending in the longitudinal direction R1 (the direction of arrow R1 in FIG. 2) of the energy absorbing member 10. In other words, the axis CL1 extends along a plate surface 41b of the first plate portion 41 and plate surfaces 42b and 42b of the pair of second plate portions 42 and 42. Incidentally, the statement that “the axis CL1 extends along each of the plate surfaces 41b, 42b, and 42b” is not limited to a configuration in which the axis CL1 is exactly parallel to the plate surfaces 41b, 42b, and 42b, and the axis CL1 may be any straight line extending in the longitudinal direction R1 of the energy absorbing member 10. For example, as illustrated in FIG. 1, a configuration in which each of the plate surfaces 41b, 42b, and 42b is inclined, at least in part, as the plate surfaces 41b, 42b, and 42b extend from one end face 10a side toward the other end face 10b of the energy absorbing member 10 is included in the configuration in which the axis CL1 extends along each of the plate surfaces 41b, 42b, and 42b.

A straight line CL2 orthogonal to the axis CL1 and extending in a direction intersecting the plate surface 41b of the first plate portion 41 (the direction of arrow R2) is defined as a “reference line CL2 of the energy absorbing member 10 (each basic unit 20)”. It is preferable that the reference line CL2 is orthogonal to an imaginary flat plane of the first plate portion 41.

As illustrated in FIG. 2, one end face 51 of one basic unit 20 in the direction R1 (the direction of arrow R1) along the axis CL1 is defined as a “first end face 51”, and the other end face 52 is defined as a “second end face 52”. For example, the contour of the first end face 51 and the contour of the second end face 52 are different, but are each line-symmetrical with respect to the reference line CL2. Therefore, the contour of the basic unit 20 is line-symmetrical with respect to the reference line CL2.

In detail, in FIG. 1, the direction in which energy (external force) acts on the energy absorbing member 10 is denoted by Er (the direction of white arrow Er). Among the four basic units 20A to 20D, the energy first acts on the first basic unit 20A. The remaining three basic units 20B to 20D are arranged in a row in the acting direction Er of energy in the order of the second basic unit 20B, the third basic unit 20C, and the fourth basic unit 20D with respect to the first basic unit 20A. For example, a length L1 of each of the basic units 20A to 20D in the axis CL1 direction is the same for all. When the energy absorbing member 10 is gradually demolded from the tip to gradually absorb energy, the length L1 in the axis CL1 direction can also be gradually increased in the order of the basic units 20A to 20D.

The first basic unit 20A and the second basic unit 20B adjacent to the first basic unit 20A constitute a first unit group 31A on an energy input side (energy acting side) on which energy first acts from the outside. The third basic unit 20C and the fourth basic unit 20D adjacent to the third basic unit 20C constitute a second unit group 31B on a non-energy input side on which energy acts via the first and the second basic units 20A and 20B.

The first and second basic units 20A and 20B may also be referred to as the “basic units 20A and 20B on the energy input side” since energy first acts thereon from the outside. In addition, the third and fourth basic units 20C and 20D may also be referred to as the “basic units 20C and 20D on the non-energy input side” on which energy acts via the first and the second basic units 20A and 20B.

Among the basic units 20A to 20D, the basic units 20A and 20B adjacent to each other and the basic units 20C and 20D adjacent to each other are arranged opposite to each other in the direction R1 along the axis CL1. That is, the second end face 52 of the first basic unit 20A and the second end face 52 of the second basic unit 20B face each other. The first end face 51 of the second basic unit 20B and the first end face 51 of the third basic unit 20C face each other. The second end face 52 of the third basic unit 20C and the second end face 52 of the fourth basic unit 20D face each other.

The energy absorbing member 10 (each basic unit 20) includes flanges 45 and 45, which can at least be clamped by a press die, at the open-side end portions 42a and 42a of the pair of second plate portions 42 and 42. The flanges 45 and 45 are integrally molded by a flat plate extending from the open-side end portions 42a and 42a in a direction R3 in which the flanges 45 and 45 extend away from each other. The flanges 45 and 45 constitute respective press-molding end portions 46 and 46 that can be clamped by the press die. In other words, a pair of press-molding end portions 46 and 46 are molded integrally with the end portions 42a and 42a, and include a pair of flanges 45 and 45.

Next, the first basic unit 20A will be described in detail as a representative of a plurality of the basic units 20A to 20D.

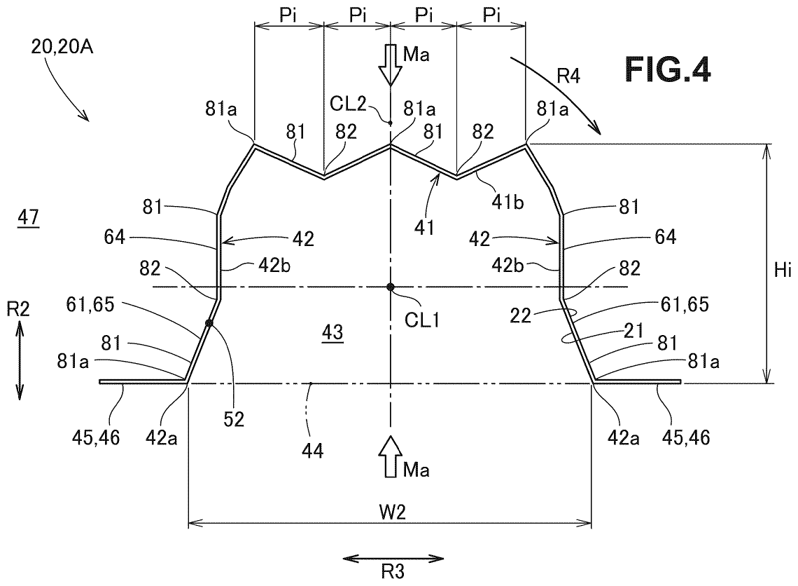

As illustrated in FIG. 2 and FIG. 4, in the first basic unit 20A, at least portions 61 and 61 (inclined surfaces 61 and 61) of the pair of second plate portions 42 and 42, which extend from both edges 41a and 41 of the first plate portion 41 to the open-side end portions 42a and 42a of the pair of second plate portions 42 and 42, are inclined in the direction R3 in which the portions 61 and 61 extend away from each other. A width between both edges 41a and 41a of the first plate portion 41 is W1 (see FIG. 3).

A width between the open-side end portions 42a and 42a of the pair of second plate portions 42 and 42 is W2, and is larger than the width W1 between both edges 41a and 41a. In this way, the pair of second plate portions 42 and 42 have a pair of the inclined surfaces 61 and 61, between which the width is wider than the width W1 between both edges 41a and 41a of the first plate portion 41.

More specifically, the pair of second plate portions 42 and 42 are composed of, at the first end face 51, a pair of first inclined portions 62 and 62 that are inclined such that the width therebetween increases as the first inclined portions 62 and 62 extend from both edges 41a and 41a of the first plate portion 41 toward the open-side end portions 42a and 42a, and first straight portions 63 and 63 parallel to the reference line CL2 from the first inclined portions 62 and 62 to the open-side end portions 42a and 42a.

Meanwhile, the pair of second plate portions 42 and 42 are composed of, at the second end face 52 on the opposite side, second straight portions 64 and 64 parallel to the reference line CL2 as the second straight portions 64 and 64 extend from both edges 41a and 41a of the first plate portion 41 toward the open-side end portions 42a and 42a, and a pair of second inclined portions 65 and 65 that are inclined such that the width therebetween increases as the second inclined portions 65 and 65 extend from the second straight portions 64 and 64 toward the open-side end portions 42a and 42a.

As a result, the pair of inclined surfaces 61 and 61 are molded between the first inclined portions 62 and 62 and the second inclined portions 65 and 65 of the pair of second plate portions 42 and 42.

As illustrated in FIG. 2 and FIG. 3, the first end face 51 of the first basic unit 20A includes at least one first protruding bent portion 71 protruding toward a space 47 (external space 47) opposite the internal space 43, and at least one first recessed bent portion 72 recessed toward the internal space 43 side beyond a tip 71a of the first protruding bent portion 71.

For example, in the first plate portion 41, two first protruding bent portions 71 and three first recessed bent portions 72 are integrally molded at the first end face 51. The first recessed bent portion 72 at the center is located on the reference line CL2 of the first basic unit 20A. The two first protruding bent portions 71 are located between the first recessed bent portion 72 and both respective edges 41a and 41a of the first plate portion 41. The remaining two first recessed bent portions 72 are located between the two respective first protruding bent portions 71 and both respective edges 41a and 41a of the first plate portion 41. The arrangement pitch of the two first protruding bent portions 71 and the three first recessed bent portions 72 is Pi. A height from the open-side end portions 42a and 42a of the second plate portions 42 and 42 to the tips 71a of the first protruding bent portions 71 is Hi.

In addition, for example, in each of the second plate portions 42 and 42, one first protruding bent portion 71 and one first recessed bent portion 72 are integrally molded at the first end face 51. The first protruding bent portions 71 are located at the boundaries between the first inclined portions 62 and 62 and the first straight portions 63 and 63. The first recessed bent portions 72 are located at the edges 41a of the first plate portion 41.

As illustrated in FIG. 2 and FIG. 4, the second end face 52 of the first basic unit 20A includes at least one second protruding bent portion 81 protruding toward the external space 47, and at least one second recessed bent portion 82 recessed toward the internal space 43 side beyond a tip 81a of the second protruding bent portion 81.

For example, in the first plate portion 41, three second protruding bent portions 81 and two second recessed bent portions 82 are integrally molded at the second end face 52. The second protruding bent portion 81 at the center is located on the reference line CL2 of the first basic unit 20A. The remaining two second protruding bent portions 81 are located between the second protruding bent portion 81 at the center and both respective edges 41a and 41a of the first plate portion 41 (see FIG. 2). The two second recessed bent portions 82 are individually located between the three second protruding bent portions 81. The arrangement pitch of the three second protruding bent portions 81 and the two second recessed bent portions 82 is Pi that is the same as that on the first end face 51 side. A height from the open-side end portions 42a and 42a of the second plate portions 42 and 42 to the tips 81a of the second protruding bent portions 81 is Hi that is the same as that on the first end face 51 side.

In addition, for example, in each of the second plate portions 42 and 42, one second protruding bent portion 81 and one second recessed bent portion 82 are integrally molded at the second end face 52. The second protruding bent portions 81 are located at the boundaries between the open-side end portions 42a and 42a of the second plate portions 42 and 42 and the second inclined portions 65 and 65. The second recessed bent portions 82 are located at the boundaries between the second straight portions 64 and 64 and the second inclined portions 65 and 65.

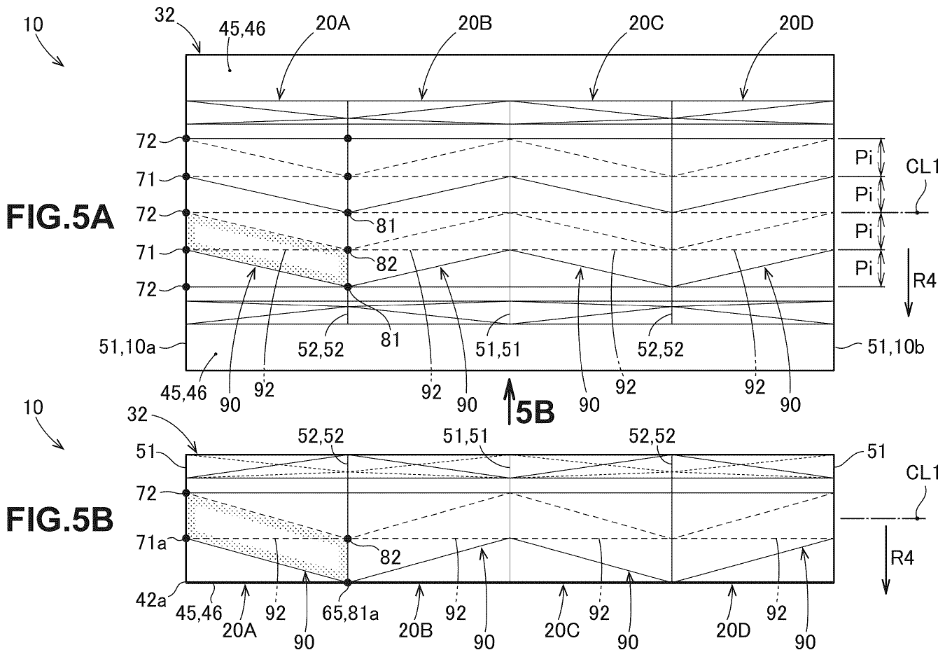

FIG. 2 and FIG. 5A illustrate the disposition relationship between the two first protruding bent portions 71 and the three first recessed bent portions 72 provided at the first end face 51 of the first plate portion 41 and the three second protruding bent portions 81 and the two second recessed bent portions 82 provided at the second end face 52 of the first plate portion 41.

The second protruding bent portions 81 provided at the second end face 52 are all biased in a clockwise direction R4 (the direction of arrow R4) when viewed from the first end face 51 side, that is, about the axis CL1 by the pitch Pi with respect to the first protruding bent portions 71 provided at the first end face 51. In addition, the second recessed bent portions 82 provided at the second end face 52 are all biased in the clockwise direction R4 (the direction of arrow R4) when viewed from the first end face 51 side, that is, about the axis CL1 by the pitch Pi with respect to the first recessed bent portions 72 provided at the first end face 51. To summarize the above description, as illustrated in FIG. 2 to FIG. 4, FIG. 5, and FIG. 5B, in the first basic unit 20A, the bent portions 81 and 82 are biased, for example, along the first plate portion 41 with respect to the bent portions 71 and 72 in the first plate portion 41. In addition, in the second plate portions 42 and 42, the bent portions 81 and 82 are biased, for example, along the second plate portions 42 and 42 with respect to the bent portions 71 and 72. The bias directions of all the bent portions 81 and 82 with respect to all the bent portions 71 and 72 are the same.

Therefore, the second protruding bent portions 81 and the second recessed bent portions 82 are biased about the axis CL1 with respect to the first protruding bent portions 71 and the first recessed bent portions 72. The bent portions 71, 72, 81, and 82 adjacent to each other can be said to mold the vertices of a parallelogram. In this way, since four bent portions (vertices) 71, 72, 81, and 82 are not located on the same plane, a quadrilateral 90 that connects the bent portions 71, 72, 81, and 82 may be referred to as an “imaginary parallelogram 90” as appropriate. The imaginary parallelogram 90 is biased about the axis CL1 by the pitch Pi. It is preferable that all the imaginary parallelograms 90 have the same shape, size, and inclination.

The imaginary parallelograms 90 and 90 molded in the pair of second plate portions 42 and 42 are disposed along the open-side end portions 42a and 42a of the pair of second plate portions 42 and 42 over the entirety of the pair of inclined surfaces 61 and 61. Incidentally, the imaginary parallelograms 90 can be configured to be disposed only in a portion of the pair of second plate portions 42 and 42. In addition, the imaginary parallelograms 90 can be disposed along the entirety of only one of the pair of inclined surfaces 61 and 61.

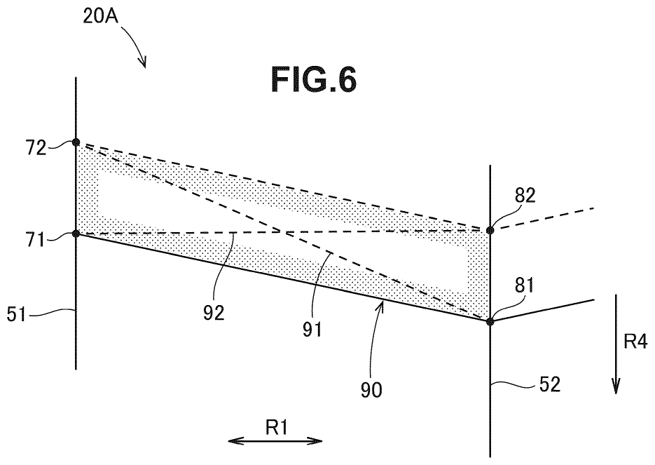

Referring also to FIG. 6, of two diagonals 91 and 92 of the imaginary parallelogram 90, one is referred to as a first diagonal 91, and the other is referred to as a second diagonal 92. The first diagonal 91 connects the first recessed bent portion 72 provided at the first end face 51 and the second protruding bent portion 81 provided at the second end face 52, and is inclined about the axis CL1 in the clockwise direction R4 when viewed from the first end face 51 side. The second diagonal 92 connects the first protruding bent portion 71 provided at the first end face 51 and the second recessed bent portion 82 provided at the second end face 52, and is aligned along the axis CL1.

The imaginary parallelogram 90 and the two diagonals 91 and 92 of the imaginary parallelogram 90 are molded, at least in part, by fold lines such as mountain fold lines or valley fold lines. It is preferable that, of the two diagonals 91 and 92, at least one diagonal 91 is molded as a fold line. More specifically, the first protruding bent portion 71 and the second protruding bent portion 81 are continuous with each other via a mountain fold line. The first recessed bent portion 72 and the second recessed bent portion 82 are continuous with each other via a valley fold line. In the first embodiment, the second diagonal 92 is molded as, for example, a valley fold line.

As illustrated in FIG. 2 and FIG. 4, when the first basic unit 20A is viewed in the direction along the axis CL1, it is preferable that each of the bent portions 71, 72, 81, and 82 has a V-shape. In addition, it is preferable that each of the diagonals 91 and 92 also has a V-shaped cross-section. Since the positions of the fold lines are made clearer by employing such a shape, the energy absorption performance of the energy absorbing member 10 can be enhanced.

As illustrated in FIG. 2 and FIG. 3, it is preferable that the boundaries between both edges 41a and 41a of the first plate portion 41 and the pair of second plate portions 42 and 42 are configured as bent portions 101 and 101 that are bent toward the open end 44 between the open-side end portions 42a and 42a of the second plate portions 42 and 42. The bent portions 101 and 101 serve as reference points when each of the protruding bent portions 71 and 81 and each of the recessed bent portions 72 and 82 are molded in the first plate portion 41 and the pair of second plate portions 42 and 42 by press molding.

As illustrated in FIG. 3 and FIG. 4, it is preferable that a circumferential length (developed length) of the U-shaped cross-section of the first end face 51 is the same as a circumferential length (developed length) of the U-shaped cross-section of the second end face 52.

As illustrated in FIG. 1, FIG. 3, and FIG. 4, despite the energy absorbing member 10 (elongated member 32), that is, an inner surface 21 and an outer surface 22 of the first basic unit 20A including the respective protruding bent portions 71 and 81 and the respective recessed bent portions 72 and 82, the inner surface 21 and the outer surface 22 are molded into a contour without an undercut shape (negative draft shape) when the energy absorbing member 10 is press-molded.

That is, a press-molding die composed of an upper die and a lower die is moved along the reference line CL2 in the direction of white arrow Ma (see FIG. 3 and FIG. 4) and is moved in the opposite direction to perform die removal (the die is withdrawn). If the die has an undercut shape (negative draft shape), the die cannot be withdrawn when being removed from the first basic unit 20A (energy absorbing member 10) after molding. In the invention, by employing the above-described configuration, a contour without an undercut shape is obtained.

Specifically, the inner surface 21 (including each of the bent portions 71, 72, 81, and 82) of the first basic unit 20A is composed of an orthogonal plane orthogonal to the reference line CL2, a plane facing the open end 44 side, or an inclined surface facing the open end 44 side. Moreover, the outer surface 22 (including each of the bent portions 71, 72, 81, and 82) of the first basic unit 20A is composed of an orthogonal plane orthogonal to the reference line CL2, a plane facing the side opposite the open end 44 side, or an inclined surface facing the side opposite the open end 44 side. Therefore, the contours of both the inner surface 21 and the outer surface 22 of the first basic unit 20A (energy absorbing member 10) have no undercut shape (negative draft shape).

For example, as illustrated in FIG. 2, the inclined surfaces 61 and 61 of the second plate portions 42 and 42 are inclined such that the width between the open-side end portions 42a and 42a of the second plate portions 42 and 42 is wider than the width between both edges 41a and 41a of the first plate portion 41. Moreover, the imaginary parallelograms 90 molded in the second plate portions 42 and 42 are disposed on the inclined surfaces 61 and 61 along the open-side end portions 42a and 42a of the second plate portions 42 and 42.

Furthermore, as illustrated in FIG. 1, FIG. 3, and FIG. 4, the orientation of the energy absorbing member 10 having a U-shaped cross-section, the size, material, or thickness of the energy absorbing member 10, the ratios of the widths W1 and W2 to the height Hi, the size, number, or disposition of the bent portions 71, 72, 81, and 82, the arrangement pitch Pi, and a width Wd of each of the flanges 45 and 45 are set to optimal conditions in consideration of the acting direction, acting point, and magnitude of energy (external force) acting on the energy absorbing member 10.

To summarize the first embodiment, as illustrated in FIG. 2 and FIG. 5, each basic unit 20 is molded as a press-molded article. The inner surface 21 and the outer surface 22 of the basic unit 20 configured to have a U-shaped cross-section have a contour without an undercut shape in the direction along the reference line CL2 (that is, a contour that allows the press-molding die to move). The first plate portion 41 and the pair of second plate portions 42 and 42 each have the imaginary parallelogram 90 that is biased about the axis CL1 from the first end face 51 to the second end face 52.

At least one of the two diagonals 91 and 92 of the imaginary parallelogram 90 is molded by a fold line.

Next, the function of the energy absorbing member 10 will be described.

As illustrated in FIG. 1 and FIG. 2, the basic units 20A and 20B adjacent to each other and the basic units 20C and 20D adjacent to each other are arranged opposite to each other in the direction R1 (the direction of arrow R1) along the axis CL1. For example, the second protruding bent portions 81 and 81 of the first and second basic units 20A and 20B face each other in the axis CL1 direction. The first protruding bent portions 71 and 71 of the second and third basic units 20B and 20C face each other in the axis CL1 direction. The second protruding bent portions 81 and 81 of the third and fourth basic units 20C and 20D face each other in the axis CL1 direction. Each imaginary parallelogram 90 and each second diagonal 92 arranged in each of the basic units 20A to 20D are molded as fold lines. The imaginary parallelograms 90 are biased about the axis CL1.

Energy (external force) acting on the energy absorbing member 10 in the acting direction Er is transmitted in the order of the first basic unit 20A, the second basic unit 20B, the third basic unit 20C, and the fourth basic unit 20D. Each of the basic units 20A to 20D is folded along a plurality of fold lines. Therefore, the basic units 20A to 20D are each folded in a spiral manner while being inverted relative to each other about the axis CL1 with reference to each fold line. As a result, the portions between both end faces 10a and 10b in the longitudinal direction R1 (direction along the axis CL1) collapse in a spiral manner while being inverted relative to each other, and the energy absorbing member 10 is folded such that the side surfaces come into close contact with each other, thereby absorbing energy.

Furthermore, the energy absorbing member 10 (each basic unit 20) is configured to have a hat-shaped cross-section by integrally molding the flanges 45 and 45 of the press-molding end portions 46 and 46 with the opening ends (end portions 42a and 42a) of the U-shaped cross-section. By reinforcing the rigidity of the opening ends of the energy absorbing member 10 having a U-shaped cross-section with the flanges 45 and 45, the energy absorption performance of the energy absorbing member 10 can be made uniform.

Next, second to twelfth embodiments will be described. Incidentally, the basic configurations of the second to thirteenth embodiments are common to the energy absorbing member 10 according to the first embodiment. The same reference numerals will be used for the portions common to the energy absorbing member 10 according to the first embodiment, and the detailed descriptions thereof will be omitted.

### Second Embodiment

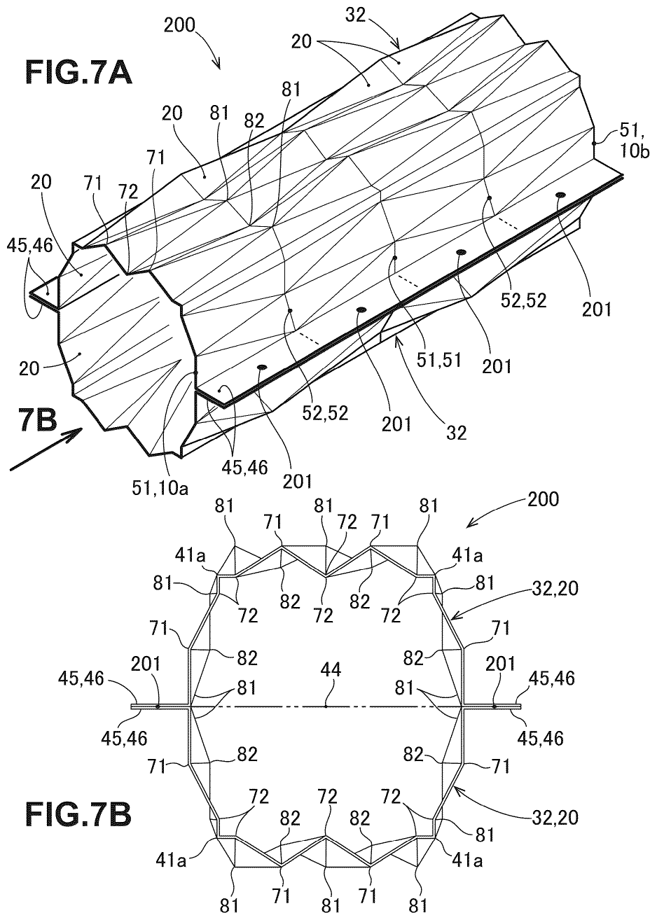

An energy absorbing member 200 of a second embodiment will be described with reference to FIG. 7A and FIG. 7B. FIG. 7A corresponds to FIG. 1. FIG. 7B corresponds to FIG. 3 and FIG. 4. The energy absorbing member 200 of the second embodiment is characterized in that two elongated members 32 of the first embodiment are superimposed face-to-face to mold a tubular shape. Specifically, the energy absorbing member 200 is configured as a tubular member by superimposing two elongated members 32 and 32, each of which has a U-shaped cross-section, that is, the open ends 44 and 44 (openings 44 and 44) of two basic units 20 and 20. The flanges 45 and 45 are joined to each other by a plurality of spot welds 201. As a result, the open-side end portions 42a and 42a of the pair of second plate portions 42 and 42 provided in the two basic units 20 and 20 are joined to each other between the first end face 51 and the second end face 52. It is preferable that the positions of the spot welds 201 are set, for example, at intermediate positions between the first end face 51 and the second end face 52.

Since the energy absorbing member 200 according to the second embodiment is configured as a tubular member, the energy absorbing member 200 can efficiently absorb a greater amount of energy. Furthermore, the energy absorbing member 200 can exhibit the same effects as those of the energy absorbing member 10 of the first embodiment, in addition to the effects of the second embodiment.

### Third Embodiment

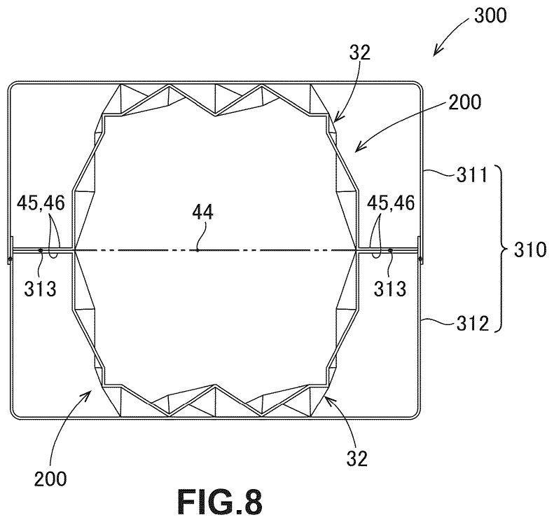

An energy absorbing member 300 of a third embodiment will be described with reference to FIG. 8. FIG. 8 corresponds to FIG. 7B. The energy absorbing member 300 of the third embodiment is characterized in that the energy absorbing member 200 of the second embodiment, that is, a tubular member composed of two elongated members 32 and 32 are incorporated into an outer cylinder 310. The outer cylinder 310 is configured, for example, by joining a pair of outer cylinder halves 311 and 312, each of which has a half-split shape, using a plurality of spot welds 313. The cross-sectional shape of the outer cylinder 310 is arbitrary, and is, for example, a rectangular shape.

The energy absorbing member 300 according to the third embodiment can absorb an even greater amount of energy by reinforcing the tubular member, which is made up of the two elongated members 32 and 32, with the outer cylinder 310. Furthermore, in the energy absorbing member 300, in order to promote deformation of the tubular member made up of the two elongated members 32 and 32, a gap may be set between the tubular member and the outer cylinder 310. Furthermore, the energy absorbing member 300 can exhibit the same effects as those of the energy absorbing members 10 and 200 of the first and second embodiments, in addition to the effects of the third embodiment.

### Fourth Embodiment

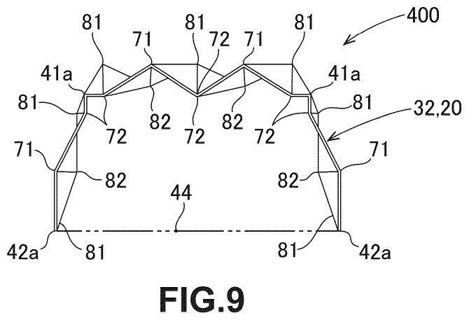

An energy absorbing member 400 of a fourth embodiment will be described with reference to FIG. 9. FIG. 9 corresponds to FIG. 2 to FIG. 4. The energy absorbing member 400 of the fourth embodiment is characterized in that the press-molding end portions 46 and 46 including the flanges 45 and 45 are removed (cut off) from the basic unit 20 of the elongated member 32 of the first embodiment illustrated in FIG. 1 to FIG. 4.

The energy absorbing member 400 according to the fourth embodiment can reduce the rigidity of the open-side end portions 42a of the second plate portions 42 due to the absence of the flanges 45. Therefore, the energy absorption performance of the energy absorbing member 400 can be made uniform throughout the cross-sections.

Furthermore, the energy absorbing member 400 can exhibit the same effects as those of the energy absorbing member 10 of the first embodiment, in addition to the effects of the fourth embodiment.

### Fifth Embodiment

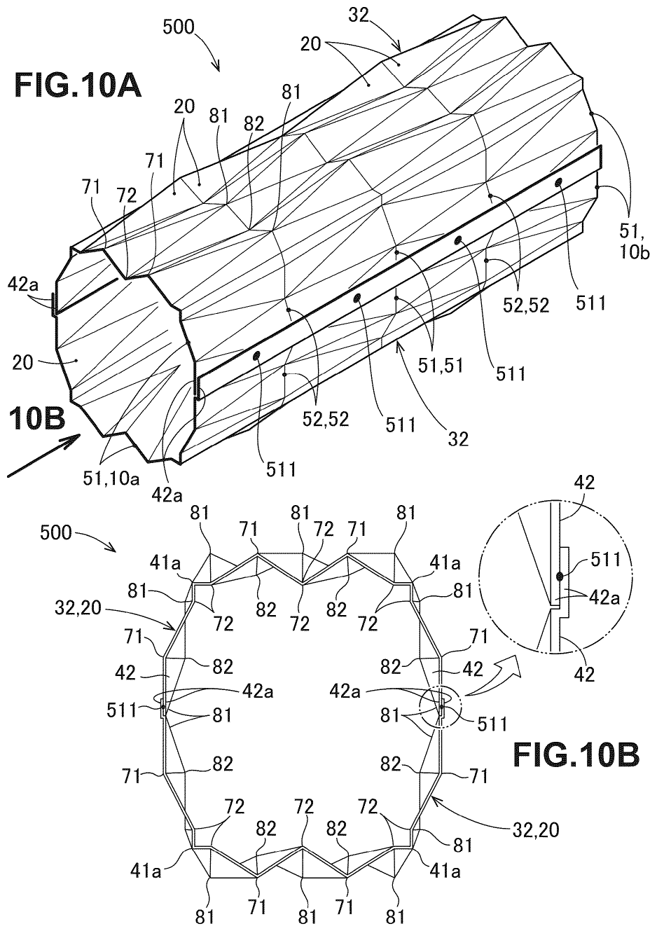

An energy absorbing member 500 of a fifth embodiment will be described with reference to FIG. 10A and FIG. 10B. FIG. 10 corresponds to FIG. 7A. FIG. 10B corresponds to FIG. 7B. The energy absorbing member 500 of the fifth embodiment is characterized in that two elongated members 32 of the fourth embodiment are superimposed face-to-face to mold a tubular shape. Specifically, the energy absorbing member 500 is configured as a tubular member by superimposing two elongated members 32 and 32, each of which has a U-shaped cross-section, that is, the open ends 44 and 44 (openings 44 and 44) of two basic units 20 and 20 illustrated in FIG. 7B.

The open-side end portions 42a and 42a of the second plate portions 42 and 42 are joined to each other between the first end face 51 and the second end face 52 by a plurality of spot welds 511. It is preferable that the positions of the spot welds 511 are set, for example, at intermediate positions between the first end face 51 and the second end face 52. Incidentally, the end portions 42a and 42a can be joined together by rivets, laser welding, or other known joining techniques instead of spot welding.

Since the energy absorbing member 500 according to the fifth embodiment is configured as a tubular member, the energy absorbing member 500 can efficiently absorb a greater amount of energy. Furthermore, the energy absorbing member 500 can exhibit the same effects as those of the energy absorbing member 400 of the fourth embodiment, in addition to the effects of the fifth embodiment.

### Sixth Embodiment

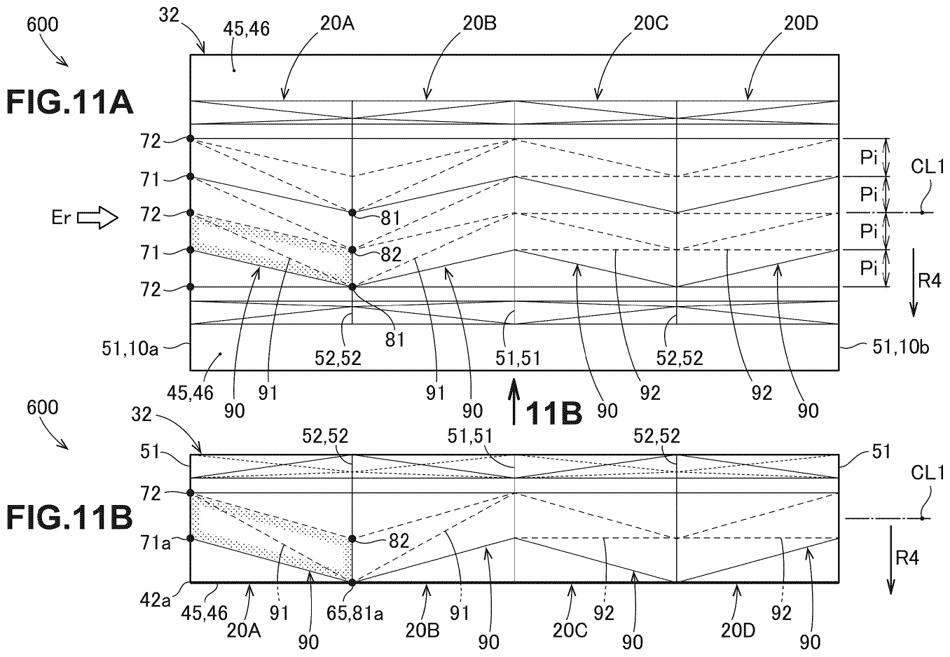

An energy absorbing member 600 of a sixth embodiment will be described with reference to FIG. 11A and FIG. 11B. FIG. 11A corresponds to FIG. 5A. FIG. 11B corresponds to FIG. 5B. The energy absorbing member 600 of the sixth embodiment is characterized by the fold lines of the two diagonals 91 and 92 of the imaginary parallelogram 90 of the first embodiment.

In the elongated member 32, the first and second basic units 20A and 20B located on the energy input side are configured such that the first diagonal 91 inclined about the axis CL1 is molded as a fold line. In the elongated member 32, the third and fourth basic units 20C and 20D on the non-energy input side, which are located on the side opposite the energy input side, are configured such that the second diagonal 92 aligned along the axis CL1 is molded as a fold line.

In the energy absorbing member 600 according to the sixth embodiment, energy absorption characteristics can be changed between the energy input side and the non-energy input side. Furthermore, the energy absorbing member 600 can exhibit the same effects as those of the energy absorbing member 10 of the first embodiment, in addition to the effects of the fifth embodiment.

### Seventh Embodiment

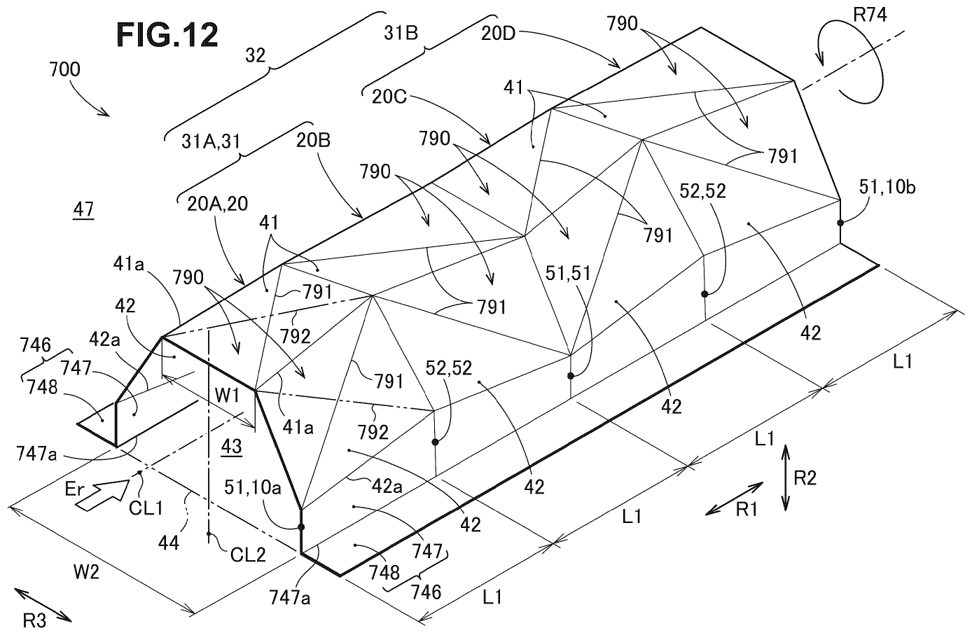

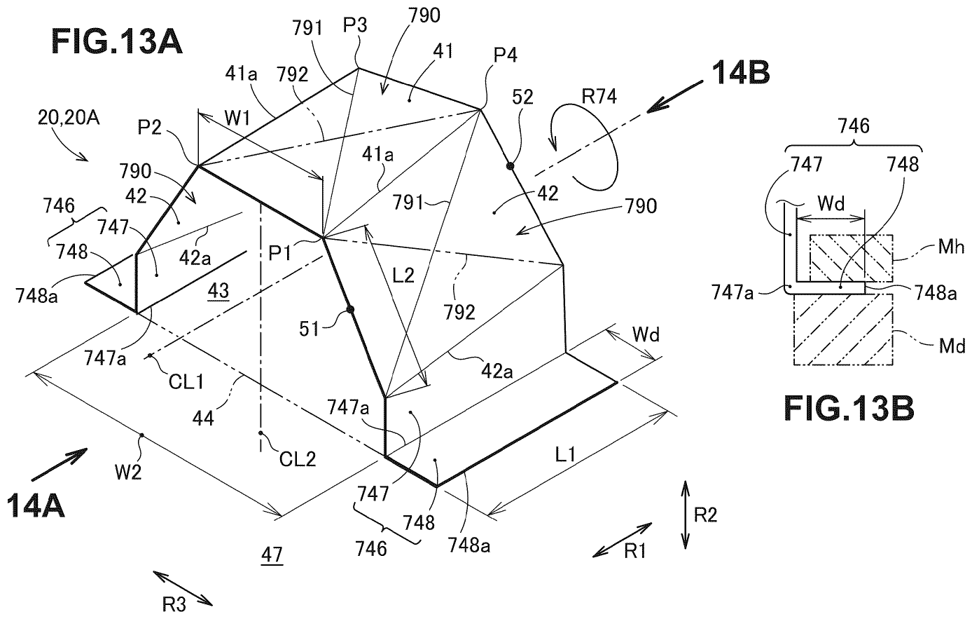

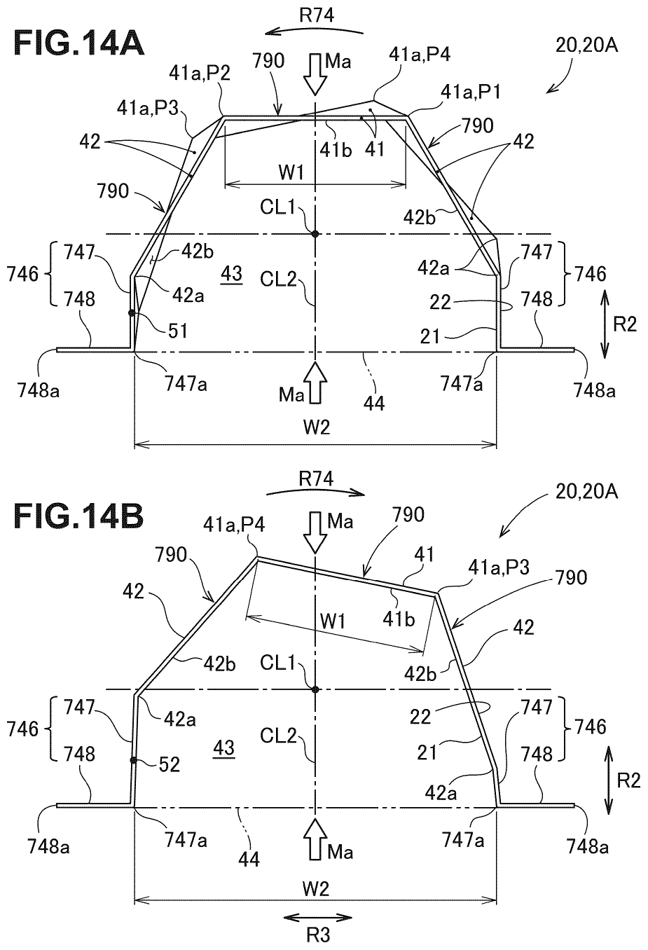

An energy absorbing member 700 of a seventh embodiment will be described with reference to FIG. 12 to FIG. 14B. FIG. 12 corresponds to FIG. 1. FIG. 13A corresponds to FIG. 2. FIG. 14A corresponds to FIG. 3. FIG. 14B corresponds to FIG. 4.

The energy absorbing member 700 of the seventh embodiment is characterized by the following two modifications made to the energy absorbing member 10 (see FIG. 1 and FIG. 2) of the first embodiment. The first modification is that the imaginary parallelogram 90 of the first embodiment is changed to an imaginary parallelogram 790. The second modification is that the press-molding end portions 46 and 46 of the first embodiment are changed to press-molding end portions 746 and 746.

As illustrated in FIG. 12 and FIG. 13A, the energy absorbing member 700 of the seventh embodiment has the imaginary parallelograms 790 in the first plate portion 41 and the second plate portions 42 and 42, but does not have the imaginary parallelogram 790 in the press-molding end portions 746 and 746. Therefore, a die for molding the energy absorbing member 700 can be easily manufactured. In addition, the energy absorbing member 700 of the seventh embodiment is the same configuration as that of the energy absorbing member 10 (see FIG. 1) of the first embodiment, and is configured in an inverted spiral folding structure by a plurality of the basic units 20 (partial structures 20) that are molded continuously and integrally.

More specifically, similarly to the energy absorbing member 10, the energy absorbing member 700 is molded as a press-molded article made of a sheet material. In the energy absorbing member 700, one member 20 configured to have a U-shaped cross-section by the first plate portion 41 and the pair of second plate portions 42 and 42 extending from both edges 41a and 41a of the first plate portion 41 in the direction in which the second plate portions 42 and 42 face each other is defined as the “basic unit 20”. When the energy absorbing member 700 is viewed in the longitudinal direction R1, the pair of second plate portions 42 and 42 spread apart from each other as the second plate portions 42 and 42 extend from both edges 41a and 41a of the first plate portion 41 toward the open-side end portions 42a and 42a. Similarly to the first embodiment, the inner surface 21 and the outer surface 22 (see FIG. 14A and FIG. 14B) of the basic unit 20 configured to have a U-shaped cross-section have a contour without an undercut shape (negative draft shape) in the direction along the reference line CL2, that is, a contour that allows a press-molding die to be moved and withdrawn along the reference line CL2.

That is, a press-molding die composed of an upper die and a lower die is moved along the reference line CL2 in the direction of white arrow Ma (see FIG. 14A and FIG. 14B) and in the opposite direction to perform die removal. If the die has an undercut shape, the die cannot be withdrawn when being removed from each basic unit 20 (energy absorbing member 10) after molding. By employing the above-described configuration, the energy absorbing member 700 has a contour without an undercut shape.

The energy absorbing member 700 (each basic unit 20) includes the press-molding end portions 746 and 746 at the respective open-side end portions 42a and 42a of the pair of second plate portions 42 and 42 so as to be capable of being cut off. The pair of press-molding end portions 746 and 746 are portions that can be clamped by the press die when the energy absorbing member 700 (each basic unit 20) is press-molded using a sheet material, and are continuous in the longitudinal direction R1 of the energy absorbing member 10 from the first end face 51 to the second end face 52 of the basic unit 20.

The pair of press-molding end portions 746 and 746 are composed of a pair of extension portions 747 and 747 extending from the open-side end portions 42a and 42a of the second plate portions 42 and 42 toward the side opposite the first plate portion 41, and the pair of flanges 45 and 45 provided at open-side end portions 747a and 747a of the extension portions 747 and 747. The pair of extension portions 747 and 747 (straight portions 747 and 747) are flat plate-shaped portions molded integrally with the pair of second plate portions 42 and 42, facing each other and parallel to the reference line CL2. The pair of flanges 748 and 748 are flat plates molded integrally with the pair of extension portions 747 and 747, and extend from the respective open-side end portions 747a and 747a of the extension portions 747 and 747 in the direction R3 in which the flanges 748 and 748 extend away from each other.

As illustrated in FIG. 13B, the flange 748 is set to at least such a size that the flange 748 can be clamped by the press die. For example, a width Wd of the flange 748 (the length Wd from the open-side end portion 747a to a tip 748a of the flange 748) is such a size that the flange 748 can be clamped by a blank holder Mh and a die Md.

In this way, the energy absorbing member 700 (each basic unit 20) is configured to have a hat-shaped cross-section by including the press-molding end portions 746 and 746, which include the pair of flanges 748 and 748 that can at least be clamped by the press die, at the open-side end portions 42a and 42a of the pair of second plate portions 42 and 42.

A region between the open-side end portions 747a and 747a of the pair of extension portions 747 and 747 is the open end 44 communicating with the internal space 43. The open end 44 plays the same role as the open end 44 of the first embodiment illustrated in FIG. 3.

The width between both edges 41a and 41a of the first plate portion 41 is W1. The width between the open-side end portions 42a and 42a of the pair of second plate portions 42 and 42 is W2, and is larger than the width W1 between both edges 41a and 41a of the first plate portion 41. A width between the open-side end portions 747a and 747a of the pair of extension portions 747 and 747 is the same as the width W2 between the open-side end portions 42a and 42a of the pair of second plate portions 42 and 42. Incidentally, in consideration of the removability of the die, the width W2 between the end portions 747a and 747a may be set slightly larger.

Next, the first basic unit 20A will be described in detail as a representative of a plurality of the basic units 20 (basic units 20A to 20D) constituting the energy absorbing member 700.

The first plate portion 41 and the pair of second plate portions 42 and 42 are biased about the axis CL1 as the first plate portion 41 and the second plate portions 42 and 42 extend from the first end face 51 toward the second end face 52. For example, the first plate portion 41 is biased about the axis CL1 in the direction of arrow R74 (counterclockwise direction R74 when viewed from the first end face 51 side). The direction of arrow R74 may be referred to as a “bias direction R74”. As one example, at the first end face 51 illustrated in FIG. 14A, the plate surface 41b of the first plate portion 41 is parallel to the surfaces (flange surfaces) of the pair of flanges 748 and 748 that are horizontal. In contrast, at the second end face 52 illustrated in FIG. 14B, the plate surface 41b of the first plate portion 41 is not parallel to the surfaces of the pair of flanges 748 and 748. The pair of second plate portions 42 and 42 are biased about the axis CL1 in accordance with the bias of the first plate portion 41.

The width W1 between both edges 41a and 41a of the first plate portion 41 at the second end face 52 is the same as, for example, the width W1 between both edges 41a and 41a at the first end face 51. That is, the width W1 of the first plate portion 41 is uniform from the first end face 51 to the second end face 52. A length L2 (see FIG. 13A) from both edges 41a and 41a of the first plate portion 41 to the open-side end portions 42a and 42a of the second plate portions 42 and 42 are uniform, for example, from the first end face 51 to the second end face 52. It is preferable that the length L2 is the same as the width W1 of the first plate portion 41.

The first plate portion 41 and the pair of second plate portions 42 and 42 each have three “imaginary parallelograms 790” that are biased about the axis CL1 in the bias direction R74 from the first end face 51 to the second end face 52. One imaginary parallelograms 790 is provided over the entire surface of the first plate portion 41. The remaining two imaginary parallelograms 790 are provided over the entire surfaces of each of the second plate portions 42 and 42.

Here, referring to FIG. 13A, FIG. 14A, and FIG. 14B, the imaginary parallelogram 790 provided in the first plate portion 41 will be described as an example. Among four vertices P1 to P4 of the imaginary parallelogram 790, the first vertex P1 and the second vertex P2 are located at the first end face 51, and the third vertex P3 and the fourth vertex P4 are located at the second end face 52. At the second end face 52, the third vertex P3 is located on the front side in the bias direction R74, and the fourth vertex P4 is located on the rear side. Therefore, the third vertex P3 is located lower than the fourth vertex P4.

In this way, since the four vertices P1 to P4 are located on the same plane, the parallelogram 790 is referred to as the imaginary parallelogram 790. The four vertices P1 to P4 of the imaginary parallelogram 790 provided in the first plate portion 41 are located at the four corners of the first plate portion 41. The imaginary parallelogram 790 provided in the first plate portion 41 has the side between the first and second vertices P1 and P2 and the side between the third and fourth vertices P3 and P4 as a pair of imaginary opposite sides, and the side between the first and fourth vertices P1 and P4 and the side between the second and third vertices P2 and P3 as a pair of imaginary opposite sides.

Of two diagonals 791 and 792 of the imaginary parallelogram 790, one is referred to as a first diagonal 791, and the other is referred to as a second diagonal 792. The first diagonal 791 connects the first vertex P1 and the third vertex P3. The second diagonal 792 connects the second vertex P2 and the fourth vertex P4. Therefore, it can be considered that each of the diagonals 791 and 792 is biased in the same direction as the bias direction R74 (the direction of arrow R74) of the imaginary parallelogram 790 from the first end face 51 to the second end face 52.

Each of the imaginary parallelograms 790 and 790 provided in the pair of second plate portions 42 and 42 is the same as the imaginary parallelogram 790 provided in the first plate portion 41, and the description thereof will be omitted.

At least one of the two diagonals 791 and 792 of the imaginary parallelogram 790 is molded by a fold line (a valley fold line or a mountain fold line). For example, of the two diagonals 791 and 792, the first diagonal 791 is molded by a fold line molded as a valley fold line. That is, by disposing the second vertex P2 and the fourth vertex P4 higher than the first vertex P1 and the third vertex P3, the first diagonal 791 is molded as a valley fold line. Incidentally, in order to mold the first diagonal 791 as a mountain fold line, the vertical relationship of the first vertex P1 and the third vertex P3 with respect to the second vertex P2 and the fourth vertex P4 may be set in reverse.

Next, the function of the energy absorbing member 700 will be described.

As illustrated in FIG. 12 and FIG. 13A, the basic units 20A and 20B adjacent to each other and the basic units 20C and 20D adjacent to each other are arranged opposite to each other in the direction R1 (the direction of arrow R1) along the axis CL1. For example, the respective imaginary parallelograms 790 and 790 of the first and second basic units 20A and 20B face each other in the axis CL1 direction. The respective imaginary parallelograms 790 and 790 of the second and third basic units 20B and 20C face each other in the axis CL1 direction. The respective imaginary parallelograms 790 and 790 of the third and fourth basic units 20C and 20D face each other in the axis CL1 direction. Each imaginary parallelogram 790 and each first diagonal 791 arranged in each of the basic units 20A to 20D are molded as fold lines. The imaginary parallelograms 790 are biased about the axis CL1.

Energy (external force) acting on the energy absorbing member 700 in the acting direction Er is transmitted in the order of the first basic unit 20A, the second basic unit 20B, the third basic unit 20C, and the fourth basic unit 20D. Each of the basic units 20A to 20D is folded along a plurality of fold lines (first diagonals 791). Therefore, the basic units 20A to 20D are each folded in a spiral manner while being inverted relative to each other about the axis CL1 with reference to each fold line. As a result, the portions between both end faces 10a and 10b in the longitudinal direction R1 (direction along the axis CL1) collapse in a spiral manner while being inverted relative to each other, and the energy absorbing member 700 is folded such that the side surfaces come into close contact with each other, thereby absorbing energy.

Furthermore, the energy absorbing member 700 (each basic unit 20) is configured to have a hat-shaped cross-section by integrally molding the press-molding end portions 746 and 746 with the opening ends 42a and 42a (open-side end portions 42a and 42a of the second plate portions 42 and 42) of the U-shaped cross-section. By reinforcing the rigidity of the opening ends 42a and 42a of the energy absorbing member 700 having a U-shaped cross-section with the press-molding end portions 746 and 746, the energy absorption performance of the energy absorbing member 700 can be made uniform. Furthermore, the energy absorbing member 700 can exhibit the same effects as those of the energy absorbing member 10 of the first embodiment, in addition to the effects of the seventh embodiment.

### Eighth Embodiment

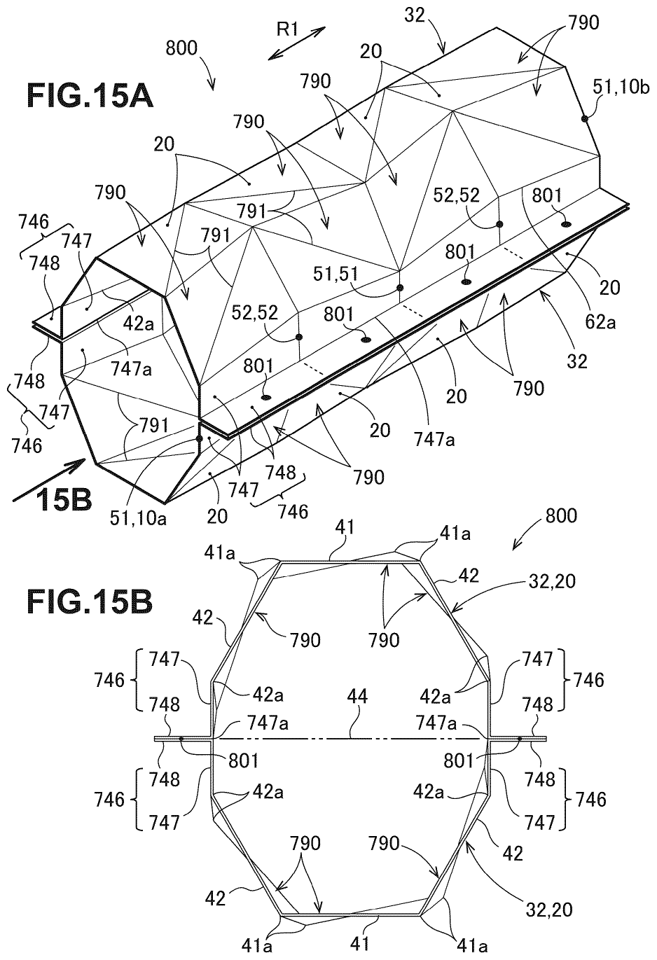

An energy absorbing member 800 of an eighth embodiment will be described with reference to FIG. 15A and FIG. 15B. FIG. 15A corresponds to FIG. 12. FIG. 15B corresponds to FIG. 14A. The energy absorbing member 800 of the eighth embodiment is characterized in that two elongated members 32 of the seventh embodiment are superimposed face-to-face to mold a tubular shape. Specifically, the energy absorbing member 800 is configured as a tubular member by superimposing two elongated members 32 and 32, each of which has a U-shaped cross-section, that is, the open ends 44 and 44 (openings 44 and 44) of two basic units 20 and 20. The flanges 748 and 748 are joined to each other by a plurality of spot welds. As a result, the open-side end portions 747a and 747a of the pair of extension portions 747 and 747 provided in the two basic units 20 and 20 are joined to each other between the first end face 51 and the second end face 52. It is preferable that the positions of spot welds 801 are set, for example, at intermediate positions between the first end face 51 and the second end face 52.

Since the energy absorbing member 800 according to the eighth embodiment is configured as a tubular member, the energy absorbing member 800 can efficiently absorb a greater amount of energy. Furthermore, the energy absorbing member 800 can exhibit the same effects as those of the energy absorbing member 700 of the seventh embodiment, in addition to the effects of the eighth embodiment.

### Ninth Embodiment

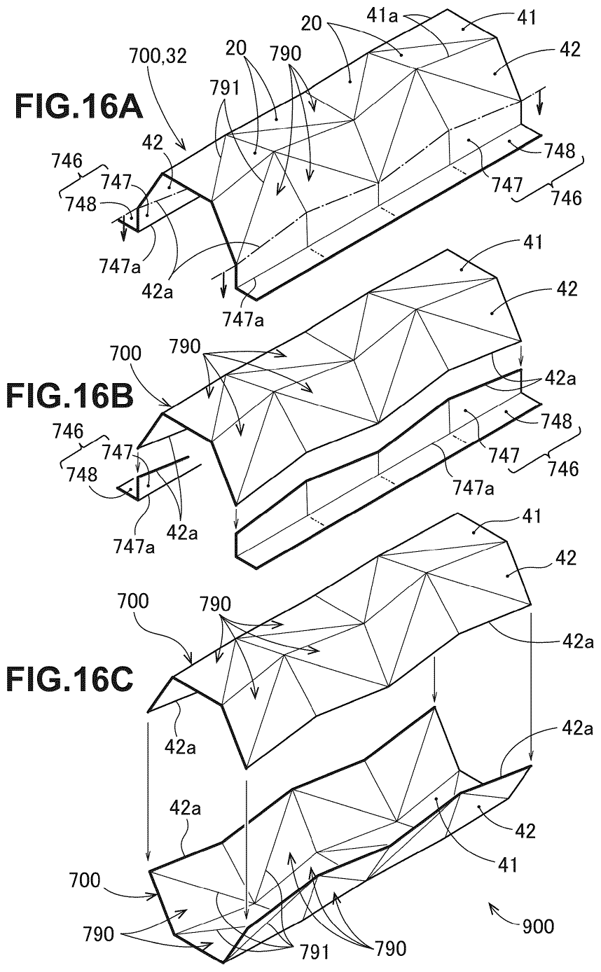

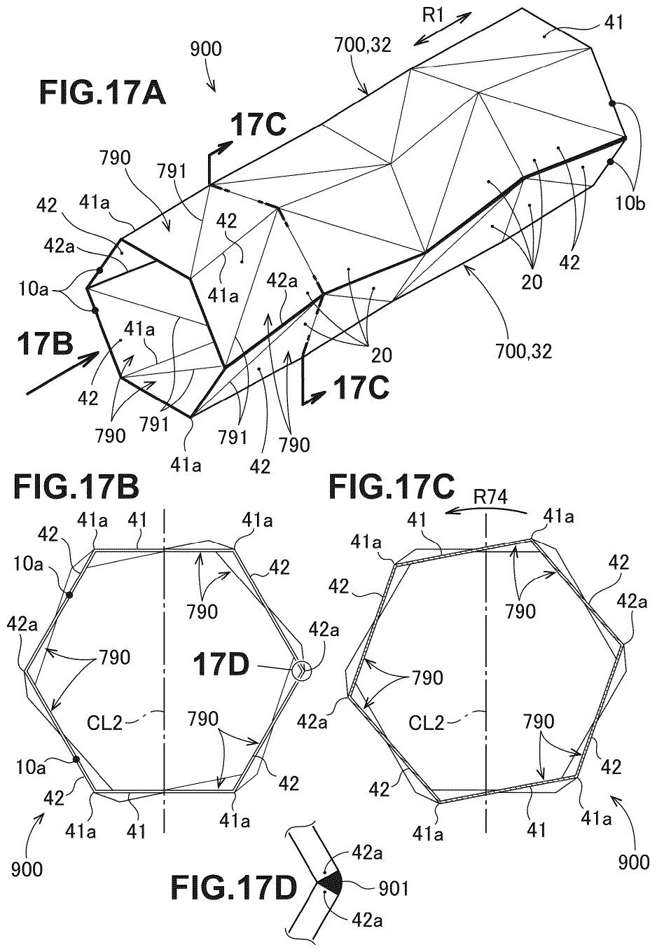

An energy absorbing member 900 of a ninth embodiment will be described with reference to FIG. 16A to FIG. 17(d). The energy absorbing member 900 of the ninth embodiment is characterized in that two energy absorbing members 700 and 700 (seventh embodiment) with the press-molding end portions 746 separated which is illustrated in FIG. 12 are superimposed face-to-face to mold a tubular shape.

Hereinafter, the ninth embodiment will be described in detail. FIG. 16A reproduces the energy absorbing member 700 of the seventh embodiment illustrated in FIG. 12. First, a manufacturing method for manufacturing the energy absorbing member 700 of the seventh embodiment to the energy absorbing member 900 (see FIG. 17A) of the ninth embodiment will be described.

First, as illustrated in FIG. 16A, the energy absorbing member 700 of the seventh embodiment that is press-molded is prepared. The energy absorbing member 700 includes the press-molding end portions 746 and 746 that can be separated from the open-side end portions 42a and 42a of the second plate portions 42 and 42 of each basic unit 20.

Next, the press-molding end portions 746 and 746 are separated (cut off) from the respective open-side end portions 42a and 42a of the second plate portions 42 and 42 of the energy absorbing member 700. As a result, as illustrated in FIG. 16B, the extension portions 747 and 747 can be separated from the end portions 42a and 42a.

Next, as illustrated in FIG. 16C, two energy absorbing members 700 and 700 with the extension portions 747 and 747 separated from the end portions 42a and 42a are prepared.

Next, the open-side end portions 42a and 42a of the second plate portions 42 and 42 of the energy absorbing members 700 and 700 are superimposed face-to-face and joined to each other. As a result, as illustrated in FIG. 17A to FIG. 17C, the energy absorbing member 900 that is molded in a tubular shape can be obtained.

As illustrated in FIG. 17A to FIG. 17C, the energy absorbing member 900 (tubular member 900) is configured to have a regular hexagonal cross-sectional shape by joining the end portions 42a and 42a.

As illustrated in FIG. 17(d), a joint structure between the end portions 42a and 42a is a joint structure using molten metal 901, for example, a joint structure using welding. The molten metal 901 is molded by melting and solidifying the end portions 42a and 42a, which serve as the base material (welding material), with filler metal.

The energy absorbing member 900 of the ninth embodiment can be summarized as follows.

The energy absorbing member 900 of the ninth embodiment is configured such that the energy absorbing member 700 illustrated in FIG. 16A is used as an “energy absorbing half 700”, and two energy absorbing halves 700 and 700 illustrated in FIG. 16C constitute a tubular member having a tubular shape.

As illustrated in FIG. 16C and FIG. 17A, the two energy absorbing halves 700 and 700 are configured such that the press-molding end portions 746 and 746 are separated from the pair of second plate portions 42 and 42, and the openings (open-side end portions 42a and 42a) are superimposed and joined together.

Since the energy absorbing member 900 of the ninth embodiment is configured as a tubular member, the energy absorbing member 900 can absorb a greater amount of energy. Furthermore, the energy absorbing member 900 can exhibit the same effects as those of the energy absorbing member 700 of the seventh embodiment, in addition to the effects of the ninth embodiment.

### Tenth Embodiment

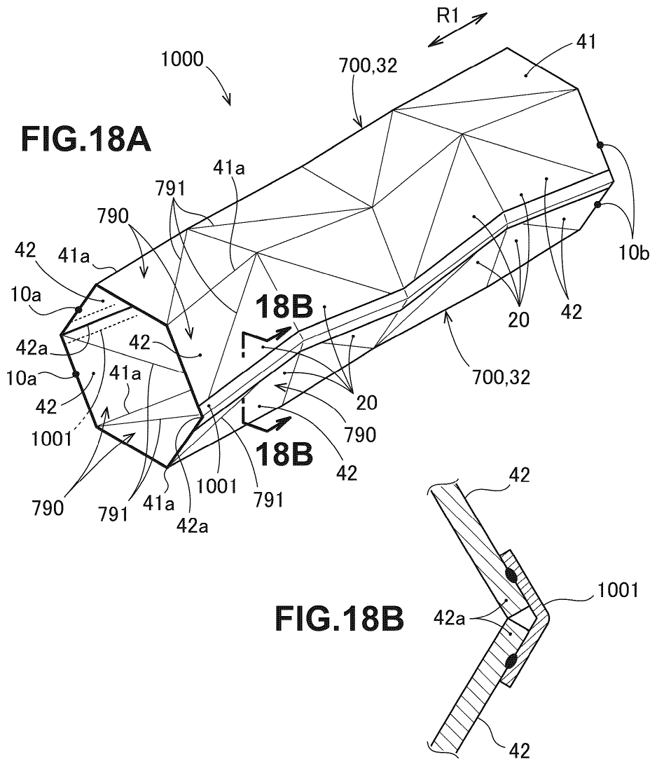

An energy absorbing member 1000 of a tenth embodiment will be described with reference to FIG. 18A and FIG. 18B. FIG. 18A corresponds to FIG. 17A. FIG. 18B corresponds to FIG. 17(d). The energy absorbing member 1000 (tubular member 1000) of the tenth embodiment is characterized in that a joint structure between the open-side end portions 42a and 42a of the second plate portions 42 and 42 is a joint structure using metal strip plates 1001 and 1001. For example, the metal strip plate 1001 is superimposed on the outer surfaces of the end portions 42a and 42a that are superimposed face-to-face. The end portions 42a and 42a are joined to each other by joining each of the end portions 42a and 42a to the strip plate 1001 using a plurality of spot welds. The other configurations are the same as those of the energy absorbing member 900 of the ninth embodiment illustrated in FIG. 16A to FIG. 17(d), and the description thereof will be omitted. The energy absorbing member 1000 can exhibit the same effects as those of the energy absorbing member 900 of the ninth embodiment.

### Eleventh Embodiment

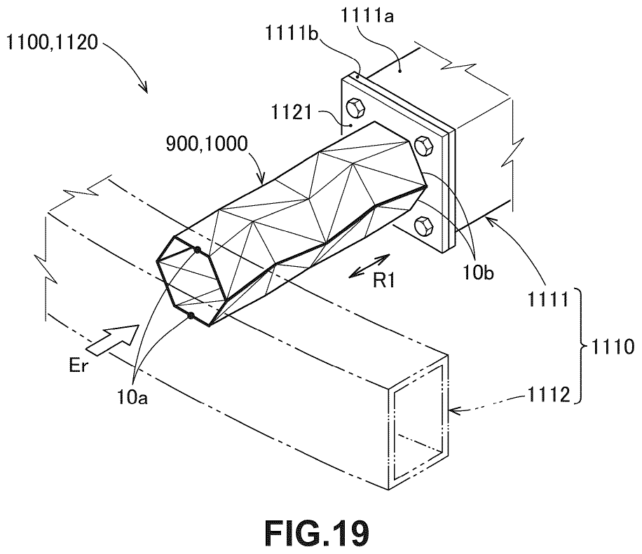

An energy absorbing member 1100 of an eleventh embodiment will be described with reference to FIG. 19. The basic structure of the energy absorbing member 1100 of the eleventh embodiment is the same as that of the energy absorbing member 900 (tubular member 900) illustrated in FIG. 17A or the energy absorbing member 1000 (tubular member 1000) illustrated in FIG. 18A. The energy absorbing member 1100 is characterized in that the energy absorbing member 1100 constitutes a crash box 1120 of a vehicle.

More specifically, the energy absorbing member 1100 includes the crash box 1120 and a flange 1121 provided at a rear end of the crash box 1120. The crash box 1120 absorbs impact energy acting from the front of a vehicle body 1110.

The vehicle body 1110 includes a front side frame 1111 and a front bumper beam 1112 (bumper reinforcement 1112) located in front of the front side frame 1111. The crash box 1120 is interposed between a connecting plate 1111b at a tip 1111a of the front side frame 1111 and the front bumper beam 1112. By bolt-fastening the flange 1121 to the connecting plate 1111b at the tip 1111a of the front side frame 1111, the energy absorbing member 1100 can be attached to the front side frame 1111.

When impact energy acts on the front bumper beam 1112 from the front of the vehicle, the impact energy acts on the crash box 1120 from the front bumper beam 1112. The crash box 1120 can absorb the impact energy through its own collapse. Furthermore, the energy absorbing member 1100 can exhibit the same effects as those of the energy absorbing member 900 of the ninth embodiment or the energy absorbing member 1000 of the tenth embodiment, in addition to the effects of the eleventh embodiment.

Incidentally, the configuration of the energy absorbing member 1100 of the eleventh embodiment can also be applied to the energy absorbing members 10 and 200 to 1000 of the first to tenth embodiments. That is, the energy absorbing members 10 and 200 to 1000 each can constitute a crash box of a vehicle.

### Twelfth Embodiment

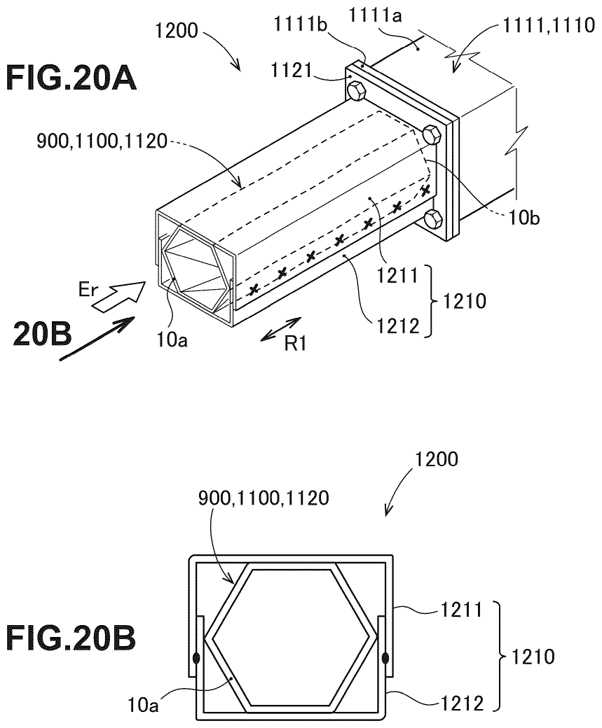

An energy absorbing member 1200 of a twelfth embodiment will be described with reference to FIG. 20A and FIG. 20B. The energy absorbing member 1200 of the twelfth embodiment is characterized in that since the energy absorbing member 1200 is housed in an outer cylinder 1210 extending in the same direction R1 (the direction of arrow R1; the longitudinal direction R1 of the energy absorbing member 1200) as the energy absorbing member 1200, the energy absorbing member 1200 is reinforced by the outer cylinder 1210. The outer cylinder 1210 is configured, for example, by joining a pair of outer cylinder halves 1211 and 1212, each of which has a half-split shape, using a plurality of spot welds. The cross-sectional shape of the outer cylinder 1210 is arbitrary, and is, for example, a rectangular shape. Similarly to the energy absorbing member 1100 of the eleventh embodiment illustrated in FIG. 19, the energy absorbing member 1200 can constitute the crash box 1120.

The energy absorbing member 1200 of the twelfth embodiment can absorb an even greater amount of energy through reinforcement with the outer cylinder 1210.

Furthermore, the energy absorbing member 1200 can exhibit the same effects as those of the energy absorbing member 1100 of the eleventh embodiment, in addition to the effects of the twelfth embodiment.

### Thirteenth Embodiment

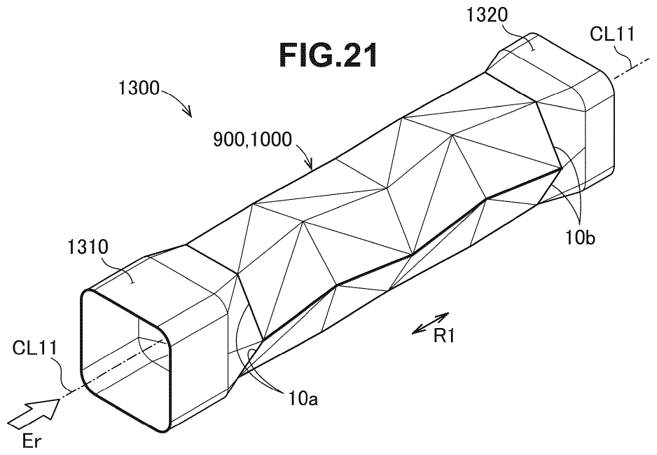

An energy absorbing member 1300 of a thirteenth embodiment will be described with reference to FIG. 21. FIG. 21 corresponds to FIG. 17A. The basic structure of the energy absorbing member 1300 of the thirteenth embodiment is the same as that of the energy absorbing member 900 (tubular member 900) illustrated in FIG. 17A or the energy absorbing member 1000 (tubular member 1000) illustrated in FIG. 18A. The energy absorbing member 1300 (tubular member 1300) of the thirteenth embodiment is characterized in that tubular bodies 1310 and 1320 are provided on both end faces 10a and 10b in the longitudinal direction R1 of the tubular member 900 or the tubular member 1000.

The tubular bodies 1310 and 1320 are located on a center line CL11 of the energy absorbing member 1300 in the longitudinal direction R1, and are joined to both end faces 10a and 10b. When the energy absorbing member 1300 is viewed in the longitudinal direction R1, the tubular bodies 1310 and 1320 are molded in a rectangular shape or a circular shape. The tubular bodies 1310 and 1320 can be assembled, for example, at any position (for example, front side frame) on a vehicle body frame (not illustrated) where an impact acting in an axial direction (direction along the center line CL11) is to be absorbed. As one example, the energy absorbing member 1300 is integrally provided in the middle of the front side frame, so that the energy absorbing member 1300 can constitute a frame structure molding a portion of the front side frame, and absorb an impact load in a front-rear direction of the vehicle body.

Furthermore, the energy absorbing member 1300 can exhibit the same effects as those of the energy absorbing member 900 of the ninth embodiment or the energy absorbing member 1000 of the tenth embodiment, in addition to the effects of the thirteenth embodiment.

The energy absorbing members 10 and 200 to 1300 of the embodiments described above are summarized below.

Referring to FIG. 1 to FIG. 21, in a first aspect, in the energy absorbing member 10 and 200 to 1300, one member 20 configured to have a U-shaped cross-section by the first plate portion 41 and the pair of second plate portions 42 and 42 extending from both edges 41a and 41a of the first plate portion 41 in the direction in which the second plate portions 42 and 42 face each other is defined as the “basic unit 20” molded as a press-molded article.

Furthermore, in the energy absorbing members 10 and 200 to 1300, the straight line CL1 passing through the space 43 (internal space 43) surrounded by the first plate portion 41 and the pair of second plate portions 42 and 42 and extending in the direction (the direction of arrow R1) along the plate surface 41b of the first plate portion 41 and the plate surfaces 42b and 42b of the pair of second plate portions 42 and 42 is defined as the “axis CL1 of the basic unit 20”, and the straight line CL2 orthogonal to the axis CL1 and extending in the direction (the direction of arrow R2) intersecting the plate surface 41b of the first plate portion 41 is defined as the “reference line CL2 of the basic unit 20”.

Furthermore, in the energy absorbing members 10 and 200 to 1300, one end face 51 of the basic unit 20 in the direction (the direction of arrow R1) along the axis CL1 is defined as the “first end face 51”, and the other end face 52 is defined as the “second end face 52”.

The inner surface 21 and the outer surface 22 (including fold lines) of the basic unit 20 configured to have a U-shaped cross-section have a contour without an undercut shape in the direction along the reference line CL2, that is, a contour that allows extrusion and withdrawal of the press-molding die. The first plate portion 41 and the pair of second plate portions 42 and 42 each have the imaginary parallelograms 90 (see FIG. 2 and FIG. 6); 790 (see FIG. 12) that are biased about the axis CL1 from the first end face 51 to the second end face 52. At least one of the two diagonals 91 and 92; 791 and 792 of the imaginary parallelograms 90; 790 is molded by a fold line.

In this way, the basic unit 20 having a U-shaped cross-section has the imaginary parallelograms 90; 790, which are biased about the axis CL1 from the first end face 51 to the second end face 52, in each of the first plate portion 41 and the pair of second plate portions 42 and 42, thereby molding the inverted spiral-type energy absorbing members 10 and 200 to 1300 with good energy absorption performance. Moreover, both the inner surface 21 and the outer surface 22 of the basic unit 20 have a contour without an undercut shape (negative draft shape). Therefore, the energy absorbing members 10 and 200 to 1300 can be easily mass-produced by relatively low-cost press molding.

Referring to FIGS. 1, 11A, 12, and 13B, in a second aspect, in the energy absorbing members 10, 600, and 700 according to the first aspect, the basic unit 20 is configured to have a hat-shaped cross-section by including the press-molding end portions 46 and 46; 746 and 746, which include the pair of flanges 45 and 45; 748 and 748 that can at least be clamped by the press die (for example, the blank holder Mh and the die Md illustrated in FIG. 13B, at the open-side end portions 42a and 42a of the pair of second plate portions 42 and 42.

By reinforcing the rigidity of the open ends 44 of the energy absorbing members 10, 600, and 700, each of which has a U-shaped cross-section, with the flanges 45 and 45; 748 and 748, the energy absorption performance of the energy absorbing members 10, 600, and 700 can be made uniform. Moreover, the basic unit 20 includes the pair of flanges 45 and 45; 748 and 748, which can at least be clamped by the press die, at the open-side end portions 42a and 42a of the pair of second plate portions 42 and 42, thereby being capable of easily mass-producing the basic unit 20 through press molding.

Referring to FIG. 5A, FIG. 5B, FIG. 6, FIG. 11A, FIG. 11B, and FIG. 12, in a third aspect, in the energy absorbing members 10, 200, and 600 according to the first and second aspects, the fold line is a valley fold line or a mountain fold line.

Since the fold line is a valley fold line or a mountain fold line, the energy absorbing members 10, 200, and 600 can be easily mass-produced by relatively low-cost press molding.

Referring to FIG. 1, FIG. 5A, FIG. 5B, FIG. 11A, FIG. 11B, and FIG. 12, in a fourth aspect, in the energy absorbing members 10, 600, and 700 according to the first to third aspects, the unit group 31 is molded by pairing two basic units 20, and at least two sets of the unit groups 31 and 31 constitute the elongated member 32 that is continuous along the axis CL1. As illustrated in FIG. 1 and FIG. 12, the basic units 20 and 20 adjacent to each other are configured such that the inclination directions of the imaginary parallelograms 90 and 90 (see FIG. 2 and FIG. 6); 790 and 790 (see FIG. 12) biased about the axis CL1 are opposite to each other.

Therefore, the energy absorbing member 10 can undergo inverted spiral deformation along the entire length of the elongated member 32 due to the fold lines, so that the amount of energy absorption is increased.

Referring to FIG. 11A and FIG. 11B, in a fifth aspect, in the energy absorbing member 600 according to the first aspect, of the two diagonals 91 and 92 of the imaginary parallelogram 90, one is defined as the first diagonal 91, and the other is defined as the second diagonal 92. The first diagonal 91 is inclined about the axis CL1 so as to be more easily folded than the second diagonal 92.

Referring also to FIG. 1, of the two sets of unit groups 31A and 31B (elongated member 32), the basic units 20A and 20B of the unit group 31A (first unit group 31A) located on the energy input side (white arrow Er side) have the first diagonals 91 molded as fold lines. Of the two sets of unit groups 31A and 31B (elongated member 32), the basic units 20C and 20D of the unit group 31B (second unit group 31B) on the non-energy input side, which is located on the side opposite the energy input side, have the second diagonals 92 molded as fold lines.

The first diagonal 91 inclined about the axis CL1 is more easily folded than the second diagonal 92 aligned along the axis CL1. Therefore, the amount of energy absorption of the basic units 20A and 20B on the energy input side (energy acting direction Er side) can be set smaller than the amount of energy absorption of the basic units 20C and 20DB on the non-energy input side. Therefore, the energy absorbing member 600 that has received input energy from the energy input side can be gradually demolded from the tip (end face 10a), and can absorb the energy while undergoing inverted spiral deformation at the portions of the fold lines along the entire length.

Referring to FIG. 7A, FIG. 7B, FIG. 8, FIG. 10A, FIG. 15A, FIG. 17A, and FIG. 18A to FIG. 20B, in a sixth aspect, the energy absorbing members 200, 300, 500, and 800 to 1200 according to the first to fifth aspects are each configured as a tubular member by superimposing the openings 44 and 44 of two basic units 20 and 20, each of which has a U-shaped cross-section. The open-side end portions 42a and 42a (see FIG. 1) of the pair of second plate portions 42 and 42 provided in the two basic units 20 and 20 are joined to each other between the first end face 51 and the second end face 52.

Since the energy absorbing members 200, 300, 500, and 800 to 1200 are each configured as a tubular member, sufficient energy absorption can be achieved even when the input energy (external force) is large. Moreover, since joining is performed along the axis CL1 between the first end face 51 and the second end face 52, the inverted spiral deformation action can be sufficiently achieved.

Referring to FIG. 7A, FIG. 8, and FIG. 15A, in a seventh aspect, in the energy absorbing members 200, 300, and 800 according to the sixth aspect, each basic unit 20 is configured to have a hat-shaped cross-section by including the press-molding end portions 46 and 46; 746 and 746, which include the pair of flanges 45 and 45; 748 and 748 that can at least be clamped by the press die, at the open-side end portions 42a and 42a of the pair of second plate portions 42 and 42. The tubular members (energy absorbing members 200, 300, and 800) are configured such that the respective flanges 45 and 45; 748 and 748 of the two basic units 20 and 20 are superimposed and joined to each other.

The two basic units 20 and 20 are configured to have a hat-shaped cross-section by including the respective flanges 45 and 45; 748 and 748. Since the energy absorbing members 200, 300, and 800 are each configured as a tubular member by joining the flanges 45 and 45; 748 and 748, a greater amount of energy (external force) can be sufficiently absorbed.

Referring to FIG. 16A to FIG. 18B, in an eighth aspect, in the energy absorbing members 900 and 1000 according to the sixth aspect, each basic unit 20 is configured to have a hat-shaped cross-section by including the press-molding end portions 746 and 746, which include the pair of flanges 748 and 748 that can at least be clamped by the press die, at the open-side end portions 42a and 42a of the pair of second plate portions 42 and 42. The tubular members (energy absorbing members 900 and 1000) are configured such that the press-molding end portions 746 and 746 are separated from the respective open-side end portions 42a and 42a of the second plate portions 42 and 42 of the two basic units 20 and 20, and the open-side end portions 42a and 42a are joined together.

Since the energy absorbing members 900 and 1000 are each configured as a tubular member, sufficient energy absorption can be achieved even when the input energy (external force) is large. Moreover, with the configuration in which the press-molding end portions 746 and 746 for easily press-molding the basic units 20 and 20 are separated and the open-side end portions 42a and 42a are joined together, the energy absorbing members 900 and 1000, each of which is molded as a tubular member, can be easily obtained.

Referring to FIG. 17A to FIG. 18(d), in a ninth aspect, in the energy absorbing members 900 and 1000 according to the eighth aspect, the tubular member has a regular hexagonal cross-sectional shape.

The energy absorbing members 900 and 1000 are molded into a tubular shape with a regular hexagonal cross-section by combining two basic units 20 and 20 configured to have a U-shaped cross-section. Therefore, both the press moldability and the energy absorption performance of the energy absorbing members 900 and 1000 can be improved.

Referring to FIG. 17A to FIG. 18B, in a tenth aspect, in the energy absorbing members 900 and 1000 according to the eighth and ninth aspects, the joint structure between the respective open-side end portions 42a and 42a of the second plate portions 42 and 42 is a joint structure using the molten metal 901 (see FIG. 17(d)) or a joint structure using the metal strip plates 1001 (see FIG. 18B).

The open-side end portions 42a and 42a of the second plate portions 42 and 42 can be integrated by joining using the molten metal 901 or joining using the metal strip plates 1001. Therefore, the energy absorbing members 900 and 1000 having a tubular shape can be relatively easily obtained by combining two basic units 20 and 20, each of which is molded as a press-molded article having a U-shaped cross-section.

Referring to FIG. 1 to 18, 19, 20A, and 20B, in an eleventh aspect, the energy absorbing members 1100 and 1200 (including the energy absorbing members 10 and 200 to 1000) according to the first to tenth aspects each constitute the crash box 1120 that can be attached to the tip 1111a of the front side frame 1111 of the vehicle body 1110 (see FIG. 19).

The energy absorbing members 1100 and 1200 (including the energy absorbing members 10 and 200 to 1000), each of which is molded as a press-molded article, can easily constitute the crash box 1120.

Referring to FIG. 8, FIG. 20A, and FIG. 20B, in a twelfth aspect, since the energy absorbing members 1100 and 1200 (including the energy absorbing members 10 and 200 to 1000) according to the first to eleventh aspects are housed in the outer cylinder 1210 (including the outer cylinder 310 in FIG. 8) extending in the same direction R1 (the direction of arrow R1) as the energy absorbing members 1100 and 1200, the energy absorbing members 1100 and 1200 are reinforced by the outer cylinder 1210.

By reinforcing the energy absorbing members 1100 and 1200 (including the energy absorbing members 10 and 200 to 1000), each of which is molded as a press-molded article, with the outer cylinder 1210 (including the outer cylinder 310 in FIG. 8), an even greater amount of energy can be absorbed.

Incidentally, the invention is not limited to the embodiments as long as the functions and effects of the invention are achieved. For example, any two or more of the embodiments may be arbitrarily combined.

### INDUSTRIAL APPLICABILITY

The energy absorbing members 10 and 200 to 1300 of the invention are suitable for application in the side sills of a vehicle body, the battery housing of an electric vehicle, and a crash box or a front side frame at the front of the vehicle body.

### EXPLANATIONS OF LETTERS OR NUMERALS

10, 200, 300, 400, 500, 600, 700, 800, 900, 1000, 1100, 1200, 1300 ENERGY ABSORBING MEMBER
10a, 10b END FACE IN THE LONGITUDINAL DIRECTION OF THE
20 BASIC UNIT
20A, 20B BASIC UNIT ON THE ENERGY INPUT SIDE
20C, 20D BASIC UNIT ON THE NON-ENERGY INPUT SIDE
21 INNER SURFACE OF THE FIRST BASIC UNIT
22 OUTER SURFACE OF THE FIRST BASIC UNIT
32 ELONGATED MEMBER
41 FIRST PLATE PORTION
41a EDGE OF THE FIRST PLATE PORTION
41b PLATE SURFACE OF THE FIRST PLATE PORTION
42 SECOND PLATE PORTION
42a OPEN-SIDE END PORTION
42b PLATE SURFACE OF THE SECOND PLATE PORTION
43 SPACE (INTERNAL SPACE)
44 OPEN END
45 FLANGE
46 EXTERNAL SPACE (OPPOSITE THE INTERNAL SPACE 43
51 FIRST END FACE
52 SECOND END FACE
61 INCLINED SURFACE (AT LEAST A PORTION OF THE SECOND PLATE PORTION)
90 IMAGINARY PARALLELOGRAM
91 FIRST DIAGONAL
92 SECOND DIAGONAL
101 BENT PORTION
201 SPOT WELD
310 OUTER CYLINDER
511 SPOT WELD
790 IMAGINARY PARALLELOGRAM
791 FIRST DIAGONAL
792 SECOND DIAGONAL
801 SPOT WELD
901 MOLTEN METAL
1001 METAL STRIP PLATE
1111 FRONT SIDE FRAME
1111a TIP
1120 CRASH BOX
1210 OUTER CYLINDER
CL1 AXIS
CL2 REFERENCE LINE
Er ACTING DIRECTION OF ENERGY (EXTERNAL FORCE)
R1 LONGITUDINAL DIRECTION OF THE ENERGY ABSORBING MEMBER
R2 DIRECTION INTERSECTING THE PLATE SURFACE OF THE FIRST PLATE PORTION
R3 DIRECTION EXTEND AWAY FROM EACH OTHER
R4, R74 DIRECTION ALONG THE PLATE SURFACE OF THE FIRST PLATE PORTION WHEN VIEWED FROM THE FIRST END FACE SIDE
W1 WIDTH BETWEEN BOTH EDGES OF THE FIRST PLATE PORTION
W2 WIDTH BETWEEN THE OPEN-SIDE END PORTIONS OF THE SECOND PLATE PORTIONS
Wd WIDTH OF THE FLANGE

1. An energy absorbing member,
wherein one member configured to have a U-shaped cross-section by a first plate portion and a pair of second plate portions extending from both edges of the first plate portion in a direction in which the second plate portions face each other is defined as a basic unit molded as a press-molded article,
a straight line passing through a space surrounded by the first plate portion and the pair of second plate portions and extending in a direction along each plate surface of the first plate portion and the pair of second plate portions is defined as an axis of the basic unit,
a straight line orthogonal to the axis and extending in a direction intersecting the plate surface of the first plate portion is defined as a reference line of the basic unit, one end face of the basic unit in a direction along the axis is defined as a first end face, and the other end face is defined as a second end face,
an inner surface and an outer surface of the basic unit configured to have a U-shaped cross-section have a contour without an undercut shape in a direction along the reference line,
the first plate portion and the pair of second plate portions each have an imaginary parallelogram that is biased about the axis from the first end face to the second end face, and
at least one of two diagonals of the imaginary parallelogram is molded by a fold line

2. The energy absorbing member according to claim 1,
wherein the basic unit is configured to have a hat-shaped cross-section by including press-molding end portions, which include a pair of flanges that can at least be clamped by a press die, at open-side end portions of the pair of second plate portions.

3. The energy absorbing member according to claim 2,
wherein the fold line is a valley fold line or a mountain fold line.

4. The energy absorbing member according to claim 3,
wherein a unit group is molded by pairing two basic units, and at least two sets of the unit groups constitute an elongated member that is continuous along the axis, and
the basic units adjacent to each other are configured such that inclination directions of the imaginary parallelograms biased about the axis are opposite to each other.

5. The energy absorbing member according to claim 4,
wherein, of the two diagonals of the imaginary parallelogram, one is defined as a first diagonal, and the other is defined as a second diagonal,
the first diagonal is inclined about the axis so as to be more easily folded than the second diagonal,
of the two sets of unit groups, the basic units of the unit group located on an energy input side have the first diagonals molded as fold lines, and
of the two sets of unit groups, the basic units of the unit group on a non-energy input side, which is located on a side opposite the energy input side, have the second diagonals molded as fold lines.

6. The energy absorbing member according to claim 1,
wherein the energy absorbing member is configured as a tubular member by superimposing openings of two basic units, each of which has a U-shaped cross-section, and
open-side end portions of the pair of second plate portions provided in the two basic units are joined to each other between the first end face and the second end face.

7. The energy absorbing member according to claim 6,
wherein the basic unit is configured to have a hat-shaped cross-section by including press-molding end portions, which include a pair of flanges that can at least be clamped by a press die, at the open-side end portions of the pair of second plate portions, and
the tubular member is configured such that the respective flanges of the two basic units are superimposed and joined to each other.

8. The energy absorbing member according to claim 6,
wherein the basic unit is configured to have a hat-shaped cross-section by including press-molding end portions, which include a pair of flanges that can at least be clamped by a press die, at the open-side end portions of the pair of second plate portions, and
the tubular member is configured such that the press-molding end portions are separated from the open-side end portions of the second plate portions of the two basic units, and the open-side end portions are joined together.

9. The energy absorbing member according to claim 8,
wherein the tubular member has a regular hexagonal cross-sectional shape.

10. The energy absorbing member according to claim 8,
wherein a joint structure between the respective open-side end portions of the second plate portions is a joint structure using molten metal or a joint structure using a metal strip plates.

11. The energy absorbing member according to claim 6,
wherein the energy absorbing member constitutes a crash box that can be attached to a tip of a front side frame of a vehicle body.

12. The energy absorbing member according to claim 11,
wherein since the energy absorbing member is housed in an outer cylinder extending in the same direction as the energy absorbing member, the energy absorbing member is reinforced by the outer cylinder.
